(19) United States
(12) Patent Application Publication
(10) Pub. No.: US 2019/0303945 A1
(43) Pub. Date: Oct. 3, 2019

(54) Smartcard Payment System and Method

(71) Applicant: Radiius Corp, Princeton, NJ (US)

(72) Inventors: Rajeshwar D. Mitra, Princeton, NJ (US); Sudhir JHA, Bengaluru (IN)

(73) Assignee: Radiius Corp, Princeton, NJ (US)

(21) Appl. No.: 16/378,803

(22) Filed: Apr. 9, 2019

Related U.S. Application Data
(62) Division of application No. 15/067,754, filed on Mar. 11, 2016.
Application No. 15/067,754 is a continuation-in-part of application No. 15/067,754, filed on Mar. 11, 2016.
(60) Provisional application No. 62/303,863, filed on Mar. 4, 2016.
(60) Provisional application No. 62/299,161, filed on Feb. 24, 2016.
(60) Provisional application No. 62/210,574, filed on Aug. 27, 2015.
(60) Provisional application No. 62/132,716, filed on Mar. 13, 2015.

(51) Int. Cl. G06Q 20/40; H04L 29/06; H04L 9/32; G06Q 20/34; G06Q 20/20; G06Q 20/32; H04L 9/08

(52) U.S. Cl. CPC G06Q 20/40145; H04L 63/0861; H04L 9/3234; G06Q 20/341; G06Q 20/3572; H04W 12/04; G06Q 20/3278; H04L 63/0853; H04L 9/3231; H04L 9/0838; H04L 2463/102; G06Q 20/204

(57) ABSTRACT

Provided is a secure universal electronic transaction card-based payment system. The system provides consumers the ability to conveniently, securely and safely use a single physical universal electronic transaction card (universal smartcard or smartcard), in a standard ISO-7810 credit card form factor that will be accepted at any standard POS device. A multiplicity of transaction account numbers, applets and or tokens are stored in a secure element from which the consumer can transact from any of their credit, debit, pre-paid, club access cards, gift cards, rewards and loyalty cards accounts, using either, Mag Stripe, EMV, or NFC at existing POS terminals.

### CROSS-REFERENCE TO RELATED APPLICATIONS

This application is a divisional application of and claims priority to U.S. application Ser. No. 15/067,754 filed on Mar. 11, 2016 which claims the benefit of U.S. Provisional Application No. 62/132,716 filed on Mar. 13, 2015, and the related subsequently filed U.S. Provisional Application Nos. 62/210,574 filed Aug. 27, 2015, U.S. Provisional Application No. 62/299,161 filed Feb. 24, 2016 and U.S. Provisional Application No. 62/303,863 filed Mar. 4, 2016, the contents all of which are incorporated herein by reference in their entireties.

### FIELD OF THE DISCLOSURE

Provided is a secure universal electronic transaction card-based payment system, which provides consumers the ability to conveniently, securely and safely use a single physical universal electronic transaction card, in a standard ISO-7810 credit card form factor, that will be accepted at any standard POS device. A multiplicity of transaction account numbers, applets and or tokens are stored in a secure element and from which the consumer can transact from any of their credit, debit, pre-paid, club access cards, gift cards, rewards and loyalty cards accounts, using either, Mag Stripe, EMV, or NFC at existing POS terminals, in such a way that only the legitimate owner of the electronic transaction card can activate, provision and unlock the electronic transaction card for use via biometric identification. After the use of the electronic transaction card, all information is locked and is unusable again without a subsequent biometric identification by the legitimate owner. In the body of this document the universal electronic transaction card will also be referred to as the universal smartcard or the smartcard.

### BACKGROUND

The problems the present disclosure addresses are providing a universal smartcard in a standard credit card form factor that provides consumers with convenience, security and universal acceptance at existing POS terminals. Current approaches that attempt to provide universal smartcards are deficient in one or more of these aspects.

Some current universal smartcards do not support all of a user's account. Some current universal smartcards do not support all types of POS terminals, mag stripe, EMV and NFC.

Some current universal smartcards do not provide sufficient security to the credit card information stored on the universal smartcard. A universal smartcard that can store multiple credit account information on the card but that does not properly secure that card from authorized use becomes a danger to the consumer in those situations where the universal smartcard is stolen or lost.

Some current universal smartcards do not exist in a standard credit card form factor. But rather they exist as contactless mobile devices that cannot be used and that are not accepted at all existing PUS terminals.

Some current universal smartcards that provide multiple account support and security do not provide the convenience of universal acceptance at all existing PUS terminals. For example, while Apple Pay supports multiple accounts and bio-metric unlocking of the iPhone, Apple Pay cannot be used at all standard PUS terminals. For example, it cannot be used in a standard mag stripe POS device. Furthermore, merchants can choose not to accept Apple Pay as some large chains have already done.

In summary, the problem of providing a universal smartcard in that is convenient, biometrically-secure, and accepted at all standard POS devices and that exists in a standard credit card form factor has not been solved.

### SUMMARY

The present disclosure relates generally to the field of providing a computer-implemented system and method that provides a secure universal electronic transaction card-based payment system, which provides consumers the ability to conveniently, securely and safely use a single physical universal electronic transaction card, in a standard ISO-7810 credit card form factor, that will be accepted at any standard POS device, into which a multiplicity of transaction account numbers, applets and or tokens are stored in a secure element and from which the consumer can transact from any of their credit, debit, pre-paid, club access cards, gift cards, rewards and loyalty cards accounts, using either, Mag Stripe, EMV, or NFC at existing POS terminals, in such a way that only the legitimate owner of the electronic transaction card can activate, provision and unlock the electronic transaction card for use via biometric identification, and after the use of the electronic transaction card all information is locked, and is unusable again without a subsequent biometric identification by the legitimate owner. In the body of this document the universal electronic transaction card will also be referred to as the universal smartcard or the smartcard.

The approach of the present disclosure provides a universal smartcard in a standard ISO-7810 credit card form factor that can be used at any standard POS terminal; that can use either mag stripe, EMV, or NFC at those terminals; that conforms to existing bank network standards; and that can store account information for multiple cards, that secures the use of the card through bio-metric identification.

Various embodiments of the present disclosure are directed to a payment and reward ecosystem in an attempt to solve the problem of carrying multiple cards, dealing with reams of paper invoices, missed opportunities to save due to expired gift cards and coupons and an overload of information related to offers. Example embodiments of components and business processes embodied in the ecosystem that can help achieve this are described in the following paragraphs.

The term “ecosystem” used herein, refers to the four main components: smartcard, smartcloud, smartmobile app/device and the smartjacket with their various supporting elements. The ecosystem encompasses all of the interaction between the four components and facilitates the communication of secure, encrypted data. The ecosystem is not limited to these main elements and may be changed or expanded in future firmware, software and hardware updates.

The term “smartcard” as used herein, refers to a type of chip card, and can be a plastic card that can comprise an embedded computer chip, (a memory, microprocessor type, or the like) that stores and transacts data. This data can be associated with either value, information, or both and can be stored and processed within the card's chip.

The term “smartcloud” as used herein, refers to the cloud system storing various information for the user. The smartcloud information can be but is not limited to card data, transaction data, coupon data, user profile and associated mobile devices. Smartcloud also acts as a gateway for integrating services from external entities such as banks, networks, service providers such as transit authorities. Smartcloud interfaces with smartmobile app/device, smartjacket and smartcard.

The term “smartmobile app/device” as used herein, refers to the paired mobile device with the smartcard-smartjacket and the associated mobile application. In certain embodiments, the mobile device does not store any card data and is a communication method between the smartcloud and smartcard. Any features and services are not limited to those mentioned in the pending document. At no point does the smartmobile app or device store payment information or card information in certain embodiments.

The term “smartjacket” as used herein, refers to a complement to the smartcard and transmits data from the smartcard to the mobile device or cloud wirelessly following using wireless protocols such as Bluetooth Smart (BLE) and WiFi. The jacket acts as a holder as well as an external battery source and in some embodiments has a set of input commands used for various functions. The smartjacket can be built on the principle of Internet of things to support the smartcard. The jacket is designed to hold the card and transfer information between the card, cloud and mobile device. The smartjacket/smartcard may form a flex assembly and in certain embodiments may be in the form of a wearable device.

### BRIEF DESCRIPTION OF THE DRAWINGS

FIG. 1 is an overview block diagram of the major components and systems involved in adding card account information and applets to a universal smartcard according to one embodiment of the present disclosure;

FIG. 2 is an overview block diagram of the smartjacket and universal smartcard and components contained therein according to one embodiment of the present disclosure;

FIG. 3 is an overview flow diagram of the process to add card account information and applets to the universal smartcard according to one embodiment of the present disclosure;

FIG. 4 is an overview flow diagram of the process to bio-metrically unlock and select a card applet for use at a standard POS terminal according to one embodiment of the present disclosure.

FIG. 5a illustrates smartcard elements in accordance with one embodiment of the present disclosure, when used with a smartjacket.

FIG. 5b illustrates smartjacket elements in accordance with one embodiment of the present disclosure.

FIG. 6 and FIG. 7 are flow diagrams outlining user creation, verification, and authentication for consumer account use in accordance with one embodiment of the present disclosure.

FIG. 8 is a flow diagram outlining logical verification of the smartcard in parallel with the physical verification for authentication.

FIG. 9 illustrates smartcard elements in accordance with one embodiment of the present disclosure.

FIG. 10 illustrates a smartcloud in accordance with one embodiment of the present disclosure, which can have a smartapplication.

FIG. 11 illustrates a smartsecure in accordance with one embodiment of the present disclosure, which is one example of how the ecosystem can be securely connected.

FIG. 12 illustrates a smartrewards in accordance with one embodiment of the present disclosure, which is an example of how location-based coupons can work through smartrewards.

FIG. 13 illustrated a smartmobile in accordance with one embodiment of the present disclosure, which is one example of a mobile application that a user can use.

FIG. 14 is a flow diagram outlining user creation, ordering and activation of the consumer account and smartcard in accordance with one embodiment of the present disclosure.

FIG. 15 is a flow diagram outlining ongoing updates for the smartcloud and smartcard in accordance with one embodiment of the present disclosure.

FIG. 16 is a flow diagram outlining one example of smartcard usage at retail outlets according to one embodiment of the present disclosure.

FIG. 17 is a flow diagram outlining one example of the process of coupons and rewards usage at a point-of-sale (POS) terminal, according to one embodiment of the present disclosure.

FIG. 18 is a flow diagram outlining the process of coupons and rewards usage at a point-of-sale terminal, according to another embodiment of the present disclosure.

FIG. 19 is a flow diagram of on store exchange according to one embodiment of the present disclosure.

FIG. 20 is a flow diagram of smartcard cancellation according to one embodiment of the present disclosure.

FIG. 21 illustrates an example of a smartcard according to one embodiment of the present disclosure.

FIG. 22 is an example of a system diagram of a smartcard payment system according to one embodiment of the present disclosure.

FIG. 23 is an example data-flow diagram illustrating communications that occur during a transaction using the smartcard payment system according to one embodiment of the present disclosure.

FIG. 24 is an example data-flow diagram illustrating communications that occur during unlocking a smartcard using the smartcard payment system according to an alternate embodiment of the present disclosure.

FIG. 25 is an example data-flow diagram illustrating another example of communications that occur during a transaction using the smartcard payment system according to another embodiment of the present disclosure.

FIG. 26 illustrates a smartsecure system according to one embodiment of the present disclosure which shows an example of how the ecosystem can be securely connected with the smartjacket acting as an extension of the smartcard.

FIG. 27 illustrates an example of a secure element on a form factor and a visual representation of the information it may hold according to one embodiment of the present disclosure.

FIG. 28 illustrates an example use-case of the secure element and its interaction with payment terminals according to one embodiment of the present disclosure.

### DETAILED DESCRIPTION

Embodiments of the present disclosure provide a system and method that provides a universal smartcard in a standard credit card form factor that can be used at any standard POS terminal; that can use either mag stripe, EMV, or NFC at those terminals; that conforms to existing bank network standards; and that can store account information for multiple cards, that secures the use of the card through bio-metric identification.

In one embodiment of the present disclosure, the following three components are provided: a mobile app residing on a mobile device, a smartjacket sleeve and its software into which a universal smartcard of the present disclosure can be docked and from which the user can be bio-metrically identified, and a universal smartcard.

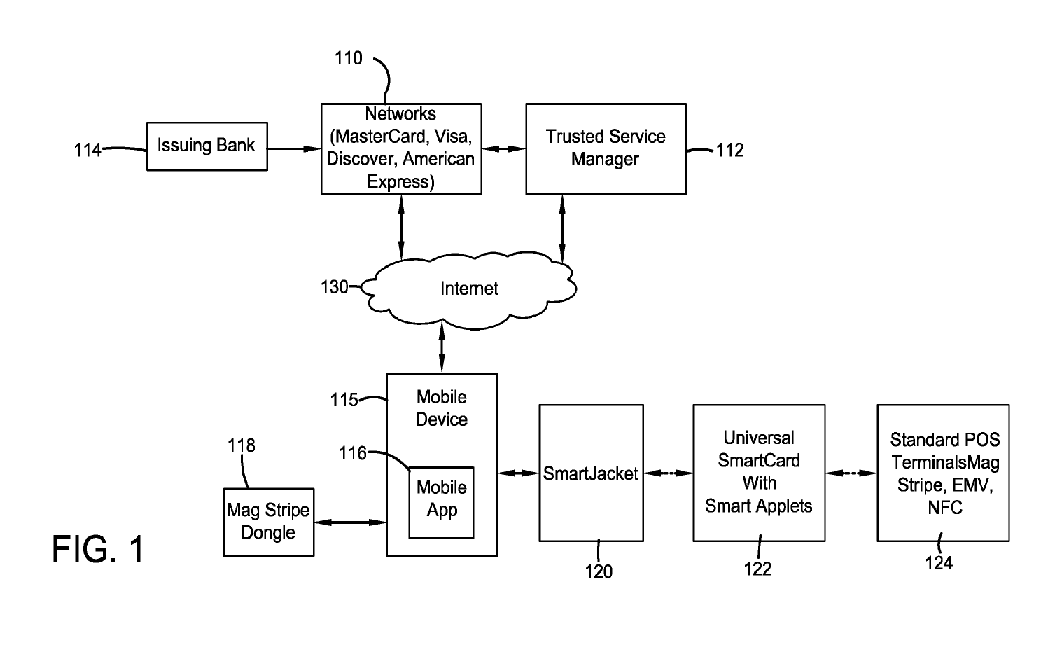

FIG. 1 is an overview block diagram of the major components and systems involved in adding card account information and applets to a universal smartcard according to one embodiment of the present disclosure

Referring to FIG. 1 in one embodiment of the present disclosure there is a mobile app 116 that resides on a mobile device 115 that is used for pairing a user with their smartjacket 120 and universal smartcard 122. The mobile device 115 can have an optional mag-stripe dongle 118 attached to it, to facilitate the swiping of card account information when adding new card account information to the universal smartcard 122. The mobile app 116 is also used for entering card account information when adding new card account information to the universal smartcard 122. The mobile app 116 is also used to communicate directly or indirectly to the networks 110, issuing banks 114 and the trusted service managers 112 to obtain the necessary tokens, CVV generators and add-card applet scripts from them when adding a new card account applet.

Still referring to FIG. 1 the smartjacket 120, is an electronic docking station for the universal smartcard which contains a biometric scanner and related software for securely selecting and unlocking a card account applet on the smartcard 122 for use at any standard POS terminal 124. The universal smartcard 122 securely stores multiple account applets inside a secure element 234 on the universal smartcard 122 for use once it is bio-metrically unlocked via the smartjacket 120 at any standard POS terminal using either mag-stripe, EMV or NFC contact or contactless connections. In certain embodiments, the smartjacket may be extended to include a casing that houses FPS, BLE (Bluetooth Low Energy), MCU (a microcontroller unit), etc.

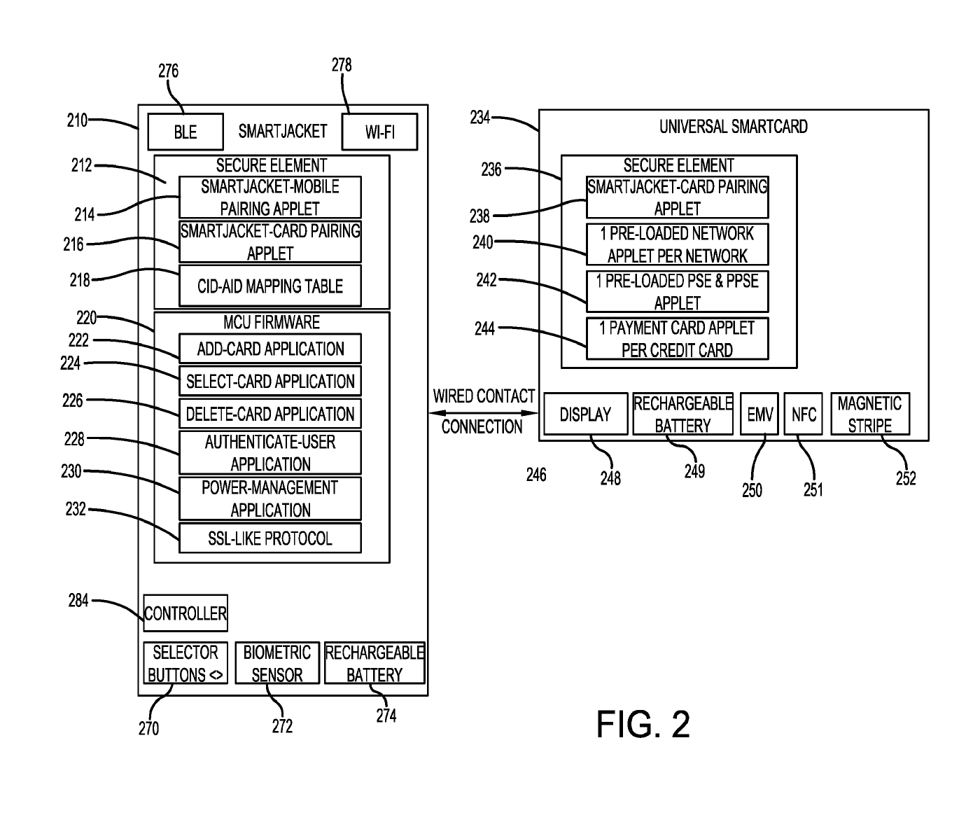

Now referring to FIG. 2, FIG. 2 is an overview block diagram of the smartjacket and universal smartcard and components contained therein according to one embodiment of the present disclosure. The smartjacket 210 contains a secure element 212 in which applets are stored including but not limited to the smartjacket-mobile pairing applet 214, the smartjacket-card pairing applet 216, and the CID-AID mapping table 218. The AID is the Network generated name given to a card account applet. The CID is a corresponding identifier generated by the smartjacket 210 in one embodiment of the present disclosure. The AID is used by the smartjacket 210 in sending commands to the universal smartcard 234 in order to select and unlock a specific payment card applet 244 for use at a POS terminal. The smartjacket 210 also has selector buttons 270, a biometric sensor 272, which in one embodiment is a fingerprint scanner, a rechargeable battery 274, a BLE (Bluetooth Low Energy) chip 276 and a Wi-Fi chip 278 and a controller 284.

Still referring to FIG. 2 of the present disclosure there is also MCU firmware 220 on the smartjacket 210 that contains various applications involved in lifecycle management, user authentication, power management and secure SSL-like protocol support for communication with the mobile device. The applications stored in the MCU firmware 220 includes but is not limited to, the add-card application 222, the select-card application 224, the delete-card application 226, the authenticate-user application 228, the power-management application 230 and the SSL-like protocol 232 component. The power-management application 230 is used to extend the battery life on the universal smartcard 234, by powering off the secure element 236 of the universal smartcard 234 when not in use.

Still referring to FIG. 2, in one embodiment of the disclosure, the universal smartcard 234 contains a secure element 236. The secure element 236 contains applets related to card account information. The applets include but are not limited to the following applets. There is the smartjacket-card pairing applet 238. The smartjacket 210 and universal smartcard 234 are paired at manufacturing time and can only be used with each other. For use the universal smartcard 234 is inserted in the smartjacket 210 and connected via a wired contact connection 246. During docking the smartjacket-card pairing applet 216 on the smartjacket 210 and the smartjacket-card pairing applet 238 on the universal smartcard 234 verify that they are properly paired. The secure element 238 on the universal smartcard 234 also contains 1 pre-loaded network applet 240 per network. Networks include but are not limited to standard credit card networks such as MasterCard, Visa, Discover and Amex. The network applets work in concert with the add-card scripts provided during the add-card process to create the payment card applets 244. There is at least one payment card applet 244 per card account. The payment card applets 244 contain the card account information, tokens and CVV generators required by the various networks. The secure element 236 also contains custom proprietary and pre-loaded PSE and PPSE applets 242. The PSE and PPSE applets 242 among other functions allow or disallow a POS terminal to access payment card applets 244 depending on whether a payment card applet is unlocked or locked. These PSE and PPSE applets 242 provide security features such as only allowing a selected payment card applet 244 to be used for one and only one use after which they are locked and cannot be unlocked and accessed by a POS terminal without a subsequent bio-metric identification at the smartjacket 210. The PSE applets are for contact connected POS terminals and the PPSE applets are for contactless POS terminals. The universal smartcard 234 also includes a dynamic display 248 which is used for, among other functions, displaying the selected card account in conjunction with the selector buttons 248 on the smartjacket 210. The universal smartcard 234, also contains a rechargeable battery 249. The universal smartcard 234 also contains contact and contactless connections and circuitry to support POS terminals including but not limited to EMV 250, NFC 251 and Mag-stripe 252.

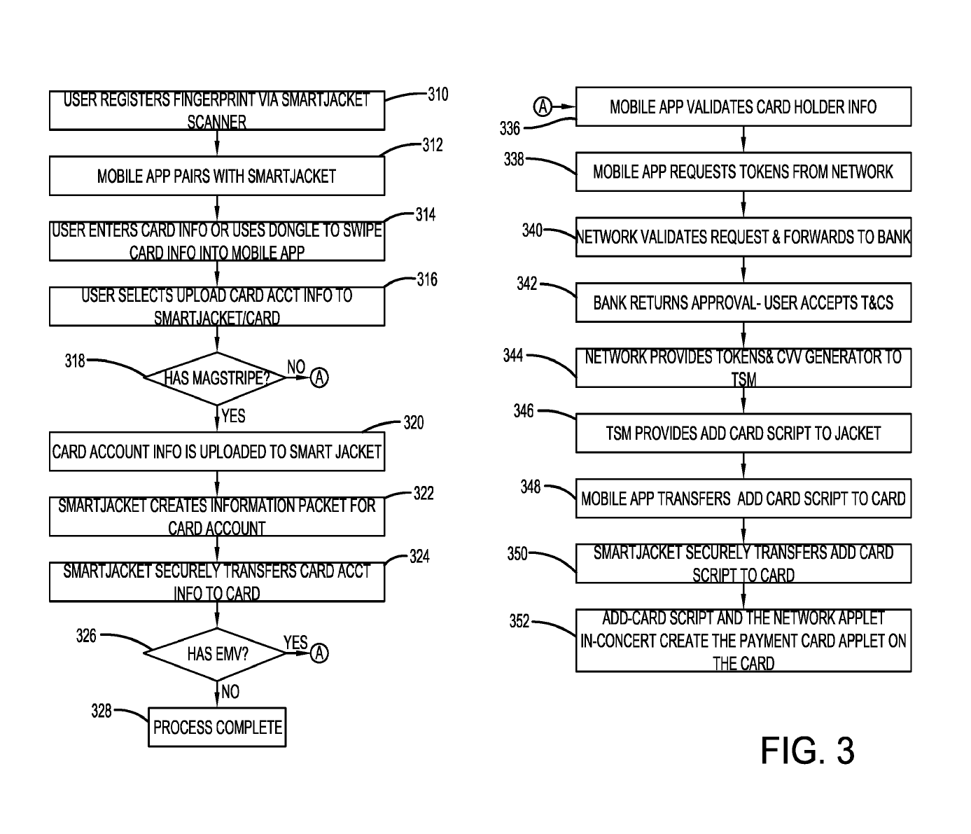

Now referring to FIG. 3, FIG. 3 is an overview flow diagram of the process to add card account information and applets to the universal smartcard according to one embodiment of the present disclosure. In step 310 the user registers their finger print via the finger print scanner on the smartjacket. In step 312 the smartjacket and the mobile app on the mobile device pair up. If a successful pairing occurs between mobile app and the smartjacket in step 314 the user either enters credit card info via the mobile app or uses the dongle attached to the mobile device to swipe the credit card information into the mobile app. In step 316 on the mobile app the user selects upload card account information to the smartjacket and card.

Still referring to FIG. 3 in one embodiment of the present disclosure at step 318 if the card has a mag-stripe the logic proceeds to step 320. In step 320 card account information is uploaded to the smartjacket. In step 322 the smartjacket creates an information packet for the mag-stripe portion of the credit card. In step 324 the smartjacket securely transfers the card account information for the mag-stripe to the universal smartcard. In step 326 if the credit card being entered is also to support EMV the logic proceeds to step 336, otherwise the process is complete.

Still referring to FIG. 3 in one embodiment of the present disclosure at step 336 the mobile app validates the card holder info, if correct it proceeds to step 338. In step 338 the mobile app requests tokens for this credit card account from the network that issued the original credit card (e.g. MasterCard, Visa, Discover, American Express). In step 340 the network forwards request to the issuing bank for approval. If approved in step 342 the bank returns approval and the T&Cs are displayed for the user to accept. Once T&Cs are accepted in step 344, the network provides tokens and the CVV generator to a trusted service manager. The trusted service manager uses these to create an add-card script which is returned to the mobile app in step 346. The add-card script is encrypted with keys that are available only to the smartcard. In step 348 the mobile app transfers the add-card script to the smartjacket. In step 350 the smartjacket securely transfers the add-card script to the card. In step 352 the add-card script in conjunction with the appropriate network applet create the payment card applet for this credit card account.

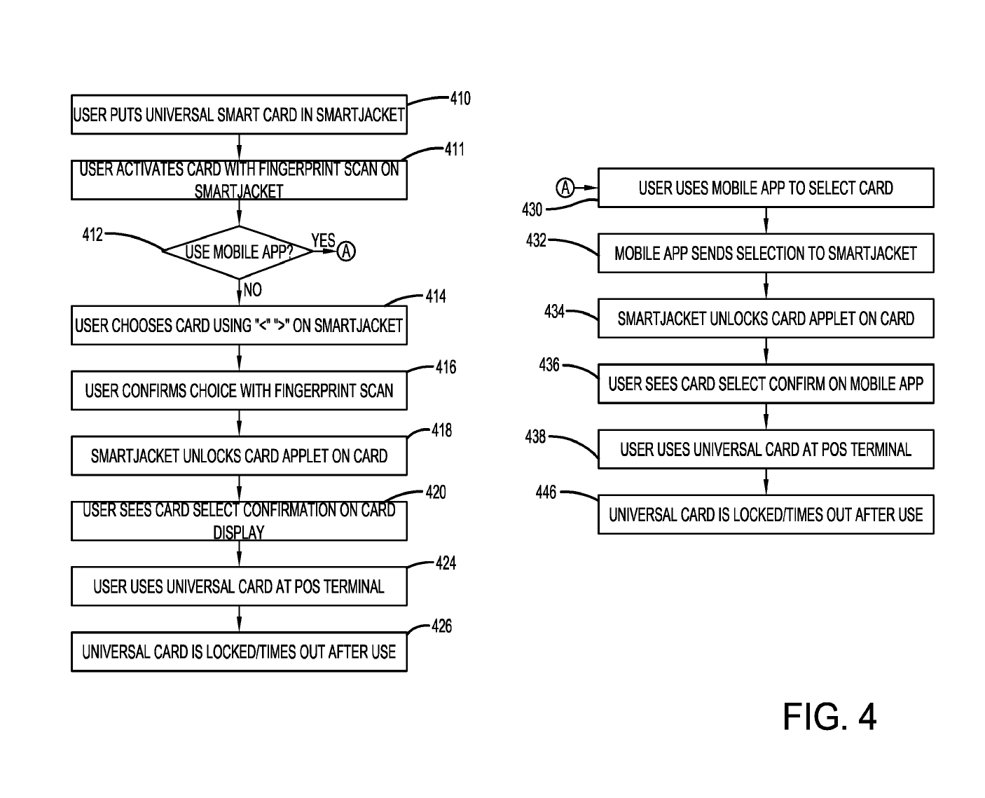

Now referring to FIG. 4, FIG. 4 is an overview flow diagram of the process to bio-metrically unlock and select a card applet for use at a standard POS terminal according to one embodiment of the present disclosure. In step 410 the user puts the universal card into the smartjacket. In step 411 the user activates the card with a fingerprint scan on the smartjacket. In step 412 if the user is going to use the mobile app to select the credit card the process proceeds to step 430. If not and the smartjacket will be used to select which credit card to use, the process proceeds to step 414.

Still referring to FIG. 4, in one embodiment of the present disclosure at step 414 the user uses the “<” and “>” buttons to select the credit card to be used on the smartjacket. The choice is displayed on the display on the universal smart card. In step 416 the user confirms choice with fingerprint scan. In step 418 the smartjacket unlocks the selected payment card applet on the card. In step 422 the user sees a confirmation of the card selection on the dynamic display on the card. In step 424, the user uses the universal card at a POS terminal for the selected credit card account. In step 426 if the card was used at an EMV or NFC terminal the card is immediately locked after one use. If the card was used at a mag-stripe POS terminal the card is locked after a specified timeout interval.

Still referring to FIG. 4, in one embodiment of the present disclosure if the user has chosen to use the mobile app to select the credit card applet to be used the process proceeds to step 430, where the user selects the credit card to be used. In one embodiment of the present disclosure in step 432 the mobile app sends a SSL-like encrypted requested via a BLE to the smartjacket specifying the selected card. In step 434 the smartjacket securely unlocks the selected payment card applet on the card. In step 436 the user sees a confirmation of the selected card on the mobile app. In step 438 the user removes the universal smartcard from the smartjacket and uses it at a POS terminal. In step 446 if the card was used at an EMV or NFC terminal the card is immediately locked after one use. If the card was used at a mag-stripe POS terminal the card is locked after a specified timeout interval.

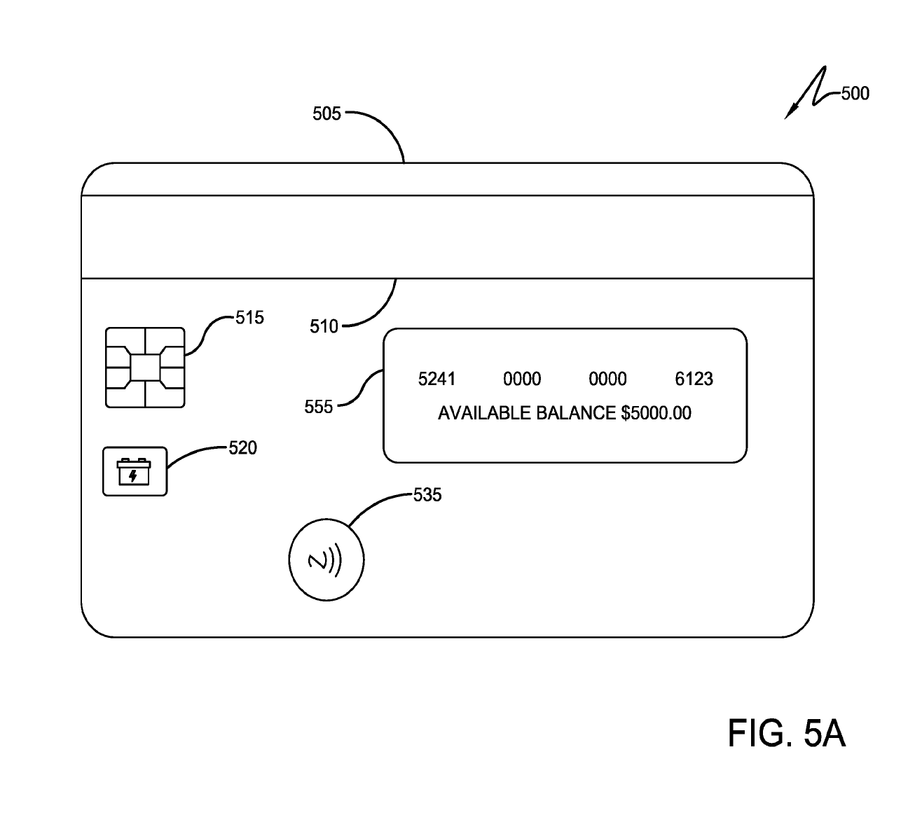

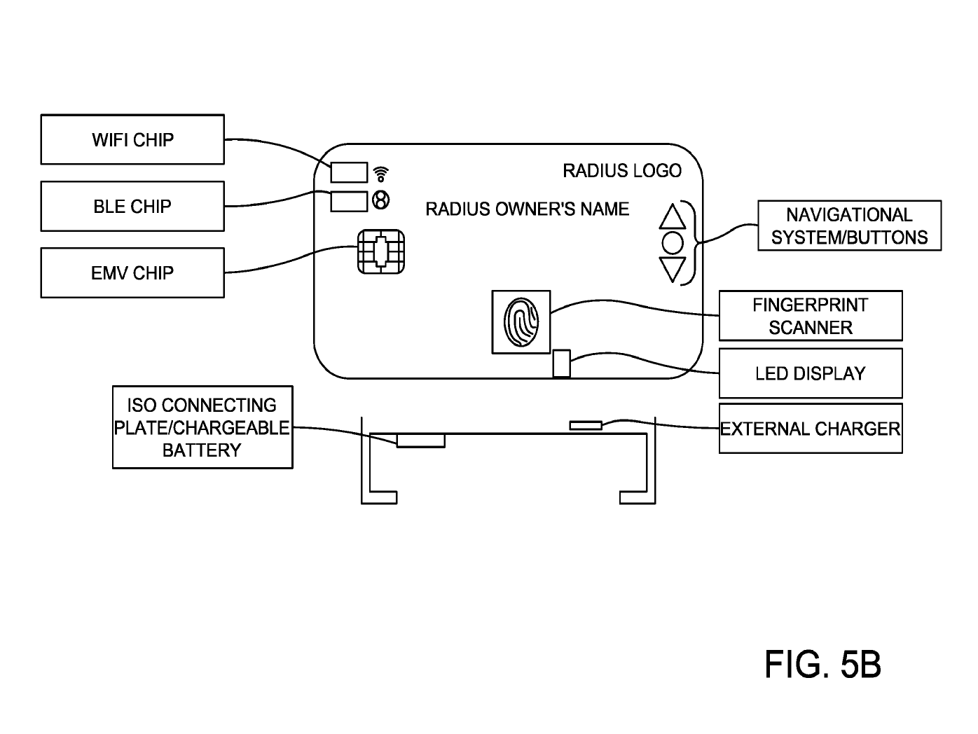

Now referring to FIG. 5a. FIG. 5a illustrates smartcard elements in accordance with one embodiment of the present disclosure when used with a smartjacket.

Referring to FIG. 5a the smart-card 500 is shown as comprising a card body 505 that includes a magnetic strip 510, an EMV chip 515, a battery 520, a near field communication (NFC) module 535 and a display 555.

The card body 505 can be any suitable shape and size in various embodiments. The card body 505 can also comprise any suitable material. For example, in some embodiments the card body 505 can conform to ISO/IEC 7810 identification card specification, including ID-000, ID-1, ID-2, ID-3 and the like. Accordingly, in some embodiments, the card body 105 can have a thickness of less than 1 mm, preferably less than 0.76 mm. Further embodiments need not conform to a standardized form factor or material specification. The smart-card 500 can comprise one or more suitable communication module configured for various desirable wireless, wired, and/or contact-based communications or data transfers. For example, the embodiment illustrated in FIG. 5a comprises a magnetic strip 510, an EMV chip 515, and a NFC module 535.

Now referring to FIG. 5b. FIG. 5b illustrates smartjacket elements in accordance with one embodiment of the present disclosure.

The term “smartjacket” as used herein, refers to a complement to the smartcard and transmits data from the smartcard to the mobile device or cloud wirelessly following using wireless protocols such as Bluetooth Smart (BLE) and WiFi. The jacket acts as a holder as well as an external battery source and in some embodiments has a set of input commands used for various functions. The smartjacket can be built on the principle of Internet of things to support the smartcard. The jacket is designed to hold the card and transfer information between the card, cloud and mobile device.

Between each of the points in the smartcard ecosystem, there is end to end encryption protecting the data being transmitted from point to point. The security is maintained between the smartjacket and smartcard by placing multiple safety features to verify user ownership. Applet is a generic name used for applications residing within the secure element on a smartcard or smartjacket. Applets will facilitate any functions within the ecosystem and may or may not be all described in the current documentation.

Applets in some embodiments, may dynamically select a card with prior user authorization and interact with a point of sale system to complete transactions as specified by the user.

Applets in various embodiments carry out functions for security, data analysis and data reading and/or writing. This includes but is not limited to support for biometric authorization; storage, management and authorized editing of payment information in multiple forms and methods including but not limited to contact and contactless EMV and magnetic stripe; recording of all access request and access allowed instances; logical interfacing between the card and jacket; encrypted communication methods and verified decryption methods. Applets in some embodiments may use or interact with hardware such as RAM and FLASH memory or use support from smartcard associated protocols using software-based security, firewalls and domains.

In other embodiments, applets may be used with the secure element to complete one or more functions which may include but are not limited to: 1.) smart jacket-card pairing; 2.) Various fields of the provisioned payment cards such as: a.) Status; b.) Tracks 1, 2 & 3; c.) Card Nickname; d.) Smartcard Identifier; e.) Application ID of the cards provisioned in smartcard (AID); f.) Application Label of the cards provisioned in smartcard (LABEL); g.) Card purpose and category; h.) UI contents for mobile handset and smartcard display (UI); 3.) Various fields of provisioned loyalty cards; 4.) Personalized data of the specific jacket such as: a.) Serial number of the jacket; b.) Hash of the jacket; c.) Hash of the corresponding card; d.) Hash of the mobile handset identifier; e.) AES-256 key to authenticate the smartcard; f.) RSA-2048 key pair (private key) to authenticate the mobile handset; g.) Backup 4-digit PIN to access sensitive data of the provisioned card on the mobile; 5.) Authenticate handset device & card SE; 6.) Send the display content to the mobile handset UI for scrolling, selecting, locking; 7.) Send the display content to the smartcard display; 8.) Send track details to dynamic magnetic stripe on the smartcard; 9.) Feeds the application identifier (AID) and label (LABEL) to the card SE to enable the particular (locked) card for both contactless (NFC based) and contact (chip-and-pin) transaction;

The smartjacket acts as a multi-use complement to the smartcard and serves many purposes. Within one embodiment, it can have buttons to navigate between the stored cards and to select one card. In other embodiments, the smartjacket can have a synch button to exchange data with the cloud and/or mobile applications. In various embodiments, the smartjacket can be used to wake the smartcard from sleep mode or verify that an action is made by the designated user within the Smartcard ecosystem using a biometric sensor.

In various embodiments, the smartcard conforms to the ISO/IEC 7810 standard for physical characteristics.

Now referring to FIG. 5b in one embodiment of the present disclosure, the smartjacket is also designed accordingly to hold the smartcard as an external body. The aesthetics of the jacket can complement the card. In various embodiments, the smartjacket includes one or more of the following components: a.) a Microprocessor or Microcontroller to control other components on the Smartcard and to transfer data between the ecosystem and external world; b.) a slot to firmly hold the smartcard and ISO connector plate, which among other uses, is used to physically connect the Smartcard and can be used to correctly orient the smartcard to the smartjacket when inserted. The outer layer may be open on one side to keep the card visible; c.) A battery for the charging of the smartcard and powering features such as the Microprocessor or any wireless communication systems; d.) a Bluetooth smart chip for low energy data transfer between the Smartcard and other trusted mobile devices. In some embodiments, the smartjacket will use the smartsecure framework to determine which external device to trust. The smartjacket can connect at point-of-sale (POS) over Bluetooth smart to collect electronic invoices; e. a low power WiFi chip to communicate with the cloud at POS and can collect appropriate card or coupon information; f.) a secure element for storing data such as secure user/card keys and user profiles as appropriate; g.) an external charger, wired or wireless; h.) an internal wireless smartcharger; i.) buttons for navigating between stored cards/coupons, selecting a card/coupon in some embodiments and synchronizing with cloud and mobile applications in other embodiments; j.) biometric scanner to switch on the Smartcard; and k. a LED which can be used for but is not limited to confirming authorization of card use, connecting to a wireless service or charging.

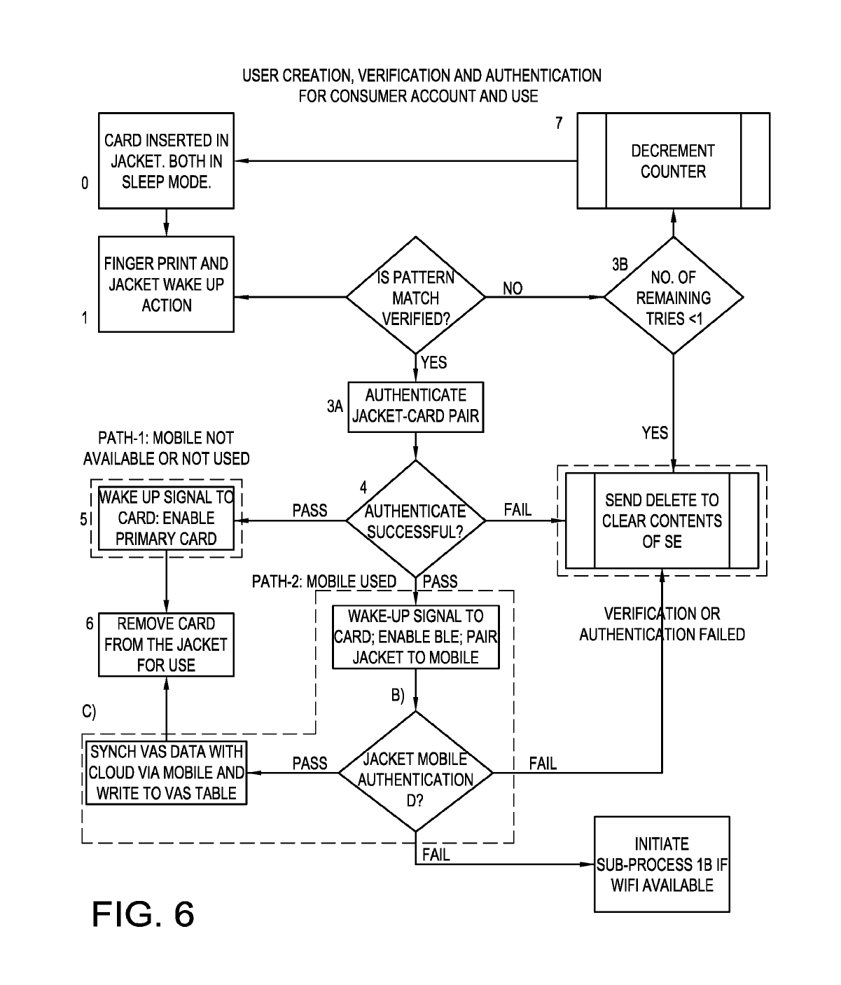

The activation of the smartcard ecosystem includes the verification of the card and user using fingerprint identification. The smartjacket will assist in this procedure by inputting the initial user's fingerprint and verifying with the appropriate mobile device, smartcloud and selected smartcard. The activation process is further described in FIG. 6.

In one embodiment of the present disclosure, placing a finger on the fingerprint scanner will wake the smartcard and smartjacket from sleep mode. Sleep mode is achieved after a determined period of time and is used to secure the ecosystem and save battery. After authentication, the smartcard is useable for a similar period of time before going back into sleep mode a. If the consumer wants additional security, the smartcard can be set to work only when the consumer mobile device is also paired.

In some embodiments, the finger sensor will act as biometric verification that the owner of the jacket is the owner of the card. In an embodiment, on first use the user places the finger on the scanner and follows a series of authentication protocols which would read and store the scan as the default. On future use, if there is a match, the card will wake up from sleep mode; else it will stay in a sleep state until “n” number of failures is reached. On the “n” instance, the jacket will render the smartcard and smartjacket unusable by disabling use until the owner reactivates via the smartcloud by providing identification.

In some embodiments, working in parallel with the physical fingerprint verification is a logical verification. The logical verification is a communication between the smartcard and the smartjacket in which the smartcard provides a passcode in an encrypted code to the smartjacket. Each smartcard and smartjacket pairing have a unique code setting which allows them to receive and read information provided by the other. In this process, the smartjacket then decrypts the code using its internal software and sends back the decrypted message to the Smartcard. If the message is recognized by the Smartcard, the logical authorization is granted. At this point, the card may be removed from the jacket and used at POS. The logical embodiment is extended by pairing with the smartmobile app/device. A BLE connection must be established to verify the user and complete authentication.

In all embodiments, to access the use of the smartcard, both the physical and logical verifications must be passed. If failure is reached “n” number of times by one or both methods, both the smartcard and smartjacket are deactivated temporarily.

In various embodiments, the BLE status of connection is reflected in the LED display. In an embodiment, the smartjacket ISO connector is required to physically connect the smartjacket and smartcard. In various embodiments, this would include voltage and GND access and access to the I/O interface.

In some embodiments, the smartjacket is operable to directly connect to cloud applications without the help of a mobile device. Alternatively, in further embodiments, if there is no Wi-Fi signal, the smartjacket can still connect to the cloud applications using smartmobile application. In various embodiments, the actual path chosen by the smartcard or smartjacket to synch with the cloud is transparent to the user.

Should the jacket connect via WiFi, the jacket may collect and transmit information regarding purchases and location. This relay of information may be stored on the smartcloud. The smartcloud may now interact with the smartjacket to display usable coupons for the location displayed by the user.

In some embodiments, the WiFi connection is automatically stored in the smartjacket with a set of default protocols and connection methods/APIs. The device can use such stored profiles and protocols to establish internet connection and publish use to any service provider. This communication to the smartcloud can transmit or receive information including location of the user, previous user expenditures, special available deals and user loyalty availability.

In some embodiments, once the jacket verifies the owner through verification process BLE should be the first device for connecting with mobile. However, should the paired mobile is not present or if the BLE could not pair with mobile, the Jacket should attempt to connect with smartcloud directly through the Wi-Fi device.

Using the smartmobile and smartcloud interaction the smartcard ecosystem will determine the best payment method for use at the location. This payment method may be determined based on points, loyalty rewards or any other rewards provided by payment methods authorized by the user. The user has the ability to choose a default payment method and does not need to accept the recommendation by the ecosystem. Should the user choose another method, this can be chosen using the navigational buttons on the smartjacket.

In an embodiment, the smartjacket uses WiFi connection to automatically download and install firmware and software updates OTA. The smartmobile app will have a similar feature to allow automatic updates.

In various embodiments, the smartmobile app can add and delete card or payment information which will then be stored on the smartcloud. The smartjacket and Smartcard may then dynamically exchange data through the smartmobile or WiFi connection at the time of purchase.

In various embodiments, should the user choose to cancel the card via the smartmobile or smartcloud, the smartcard and smartjacket will receive the information and delete all payment data. The card and jacket are then rendered unusable until reactivated by the user.

In another aspect, the present disclosure teaches a security platform ensuring that data is protected at all levels of transmission between the card and mobile device. As per a previous disclosure, the security can be ensured between the cloud, mobile device and smartcard. All data is communicated internally on a secure element and is end to end encrypted. In some embodiments, the jacket verifies use of the card through random number generation using password verification between the card and the jacket. In various embodiments, the end to end communication between the cloud, card, mobile device and jacket may use tokenization with the assistance of a third party application. Security may be changed from the time of filing and may include additional features.

Various embodiments of the present disclosure are directed to a secure element which may be found on an ISO 7810 card form factor which can store and use the information of more than one payment card or a secure element on the smartjacket for similar purposes. Example embodiments of components and business processes embodied in the ecosystem that can help achieve this are described in the following paragraphs.

The “secure element” or “SE” used herein, extends the industry standard definition of tamper-resistant platform of one or more computerized chips capable of securely hosting applications and their confidential and cryptographic data in accordance with the rules and security requirements set forth by a set of well-identified trusted authorities (derived from gobalplatform.org). The SE mentioned herein may refer to a specific card based, ISO 7810 standard, form factor secure element with the ability to hold, read and use more than one payment solutions or a supplementary SE found on the smartjacket used for payment, nonpayment or security verification (biometric or otherwise) purposes.

The “user interface” or UI used herein, refers to a navigational system provided to navigate the information of the SE. This UI may be a mobile device, physical navigational buttons or any other method which is authorized to speak directly with the SE and use and/or manage the information stored.

In certain embodiments, the information being held for each payment option will vary. Each payment option will be able to record one or more of the payment information details listed. The information on the list are possibilities and are not limited to those which are provided: a) EMV contact payment information or cryptogram used—for example—by a chip and-signature or chip-and-pin terminals; b) EMV contactless payment information or cryptogram used—for example—by a NFC based EMV terminal; c) Magnetic stripe track 1 data used by a swipe based terminal; d) Magnetic stripe track 2 data used by a swipe based terminal; e) Magnetic stripe track 3 data used by a closed system for loyalty cards; f) Personal information of the user; g) Personal information found on a physical card including but not limited to: card number, security verification number, expiration dates, authorizing bank, corresponding network or any contact information provided; h) Corresponding banks for the payment cards; i) Corresponding networks for the payment cards; j) Card authentication information—for example —symmetric and/or asymmetric keys, card identifiers (in form of hash), UI device identifier (in form of hash and ID)

In various embodiments, a payment terminal may request information to complete a transaction. Through a user interface, mobile or otherwise, a user may select a payment card stored on the SE to complete the transaction. The transaction will be verified as any payment transaction is by the vendor.

In certain embodiments, information on the SE may need to be added. For such situations, a UI will be provided to authorize and store new information to the SE. Should new information be added, it will be validated by the proper organizations before being added to the existing information.

In certain embodiments, the information on the SE may need to be removed. Through a possible user interface, the data may be removed by the managing user.

In certain embodiments, the information on the SE may need to be managed or changed. For such situations, a UI will provide a proper interface to access and change the information on the SE to any authorized user. Any changes will be verified by the appropriate authorities.

In certain embodiments, all payment information for one payment method is kept independent of all other payment information hosted on the SE. Payment information will not be exchanged between payment methods and information about transactions recorded on each payment method will not be shared with other payment methods on the SE at any time.

In certain embodiments, non-payment information may be placed on the SE with payment information. Both sets of information will remain independent from one another unless an application authorized by the user allows the exchange of information.

In various embodiments, non-payment information will remain independent from payment information. In these occasions, the user will be authorized to view and add authorized non-payment information similar to the way that payment is added.

In certain embodiments, any actions taken to change the information present on the SE will be recorded on the SE. This information will be able to be accessed by the appropriate authorities.

In certain embodiments, other controllers available on the host card will have access to the secure element. These controllers include but are not limited to Bluetooth, additional power sources, near field communication devices and other/supporting computer chips. If protocols exist on the SE, in various embodiments with the assistance of an appropriate UI, the controllers may use SE as a method of sharing, obtaining or managing information with any authorized parties. In other embodiments, the SE may use any existing protocols to communicate with other components on the host card.

In certain embodiments, the other controllers available on the host card with the SE may be able to provide an extension of another UI authorized to delete, add, manage or change the information on the SE.

In various embodiments, the SE may be placed in the standard location for SEs being used as storage spaces and payment mechanisms on payment cards.

In certain embodiments, the SE may be used to communicate and complete a transaction. In certain embodiments, should an authorized administrator gain access to the card, they may delete all information on the SE. This may be completed manually or with the assistance of any other controller present and able to communicate with the SE.

In certain embodiments, any changes or actions taken with or on the SE will be recorded on the SE. This information may be available for access by authorized users.

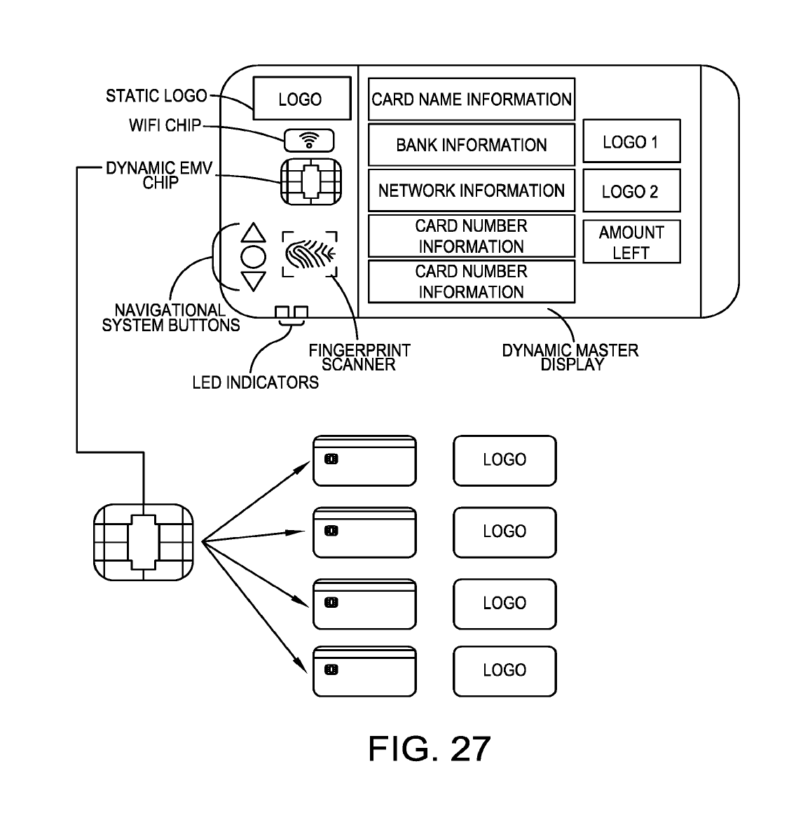

FIG. 27 illustrates the SE on an ISO 7810 form factor. This particular form factor holds additional controllers which may or may not be used by the SE at any given time. The arrow to the right of the labelled SE displays the possible information shown for each of the payment information methods recorded. The extension of the main image below shows the SE with four arrows. The four arrows point to four different payment cards, each with a different payment network. The information of the four cards remain independent from one another on the SE while the SE is able to store and use all four as necessary. The four payment cards shown are used to illustrate that more than one set of information may be held and used on the SE as needed.

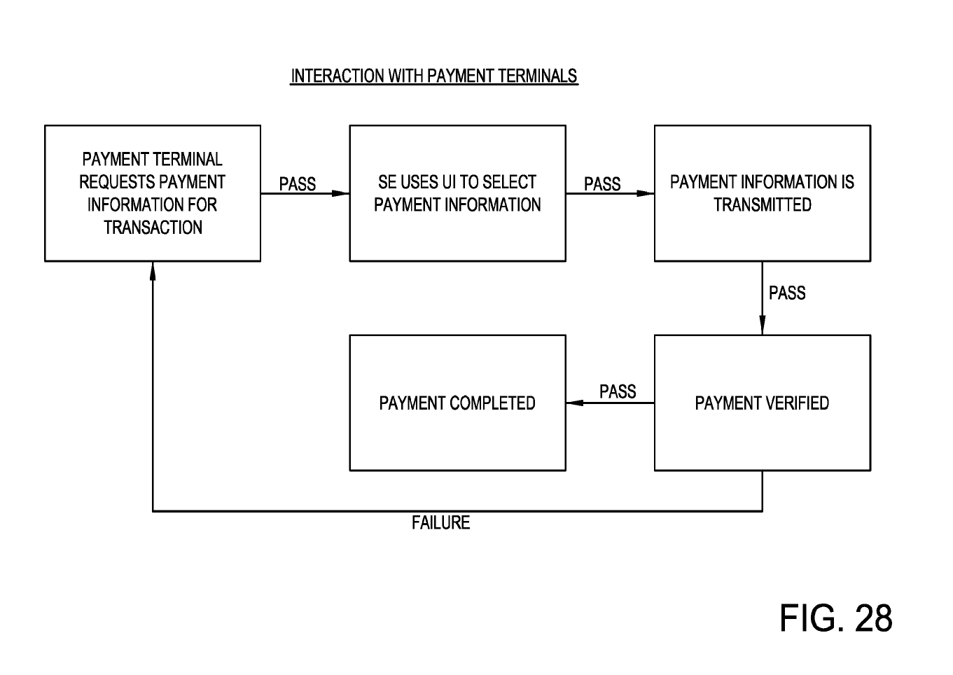

FIG. 28 illustrates a generic payment sequence using the SE. The process begins with the payment terminal requesting payment information from the user. The user, using an approved UI will choose the payment card for the transaction. If the chosen payment method is valid, the information of the payment method will be relayed to the SE. The SE will then check in the memory for the payment method and the associated information to the payment method. If this payment method is present, the SE will select the information associated to the payment method and communicate it securely to merchant payment terminals that may be swiped, tapped or inserted depending on the payment method used at the time. The payment terminal will then verify the payment information and if there is enough money, use the specified payment method for the transaction. Should the transaction fail due to a loss of connection or due to insufficient funds for the specified payment method, the payment terminal will restart the process and inform the user of the issue. If there are no issues verifying the original payment information, the transaction will be completed and the secure element will retrieve the information originally provided to the supporting controllers. In certain embodiments, all information regarding the transaction will be recorded in the secure element and the process will terminate.

Now referring to FIG. 6 in one embodiment of the present disclosure, FIG. 6 outlines the use of the smartcard in accordance with the use of the smartjacket and how the card and jacket will be paired using a mobile device. FIG. 6 shows a non-limiting case of pattern recognition for the use of the card as well as the card's authorization process after there has been a paired mobile device assigned. In step 0, the card starts in SLEEP mode. The wake up action is initiated at step 1 which leads to finger print pattern confirmation in step 2. Should the pattern be verified, it leads to 3A which leads to a card authentication pathway. In case the pattern is not verified, it leads to step 3B which checks with the internal counter “n” to the number of tries left with the fingerprint authentication. Should the number n be less than 1, it will lead to step 8. However, if the number is greater than or equal to 1, then it routes to step 7 and decreases n by 1. This leads back to step 0 to restart the process. If the process continues from 3A, the smartjacket will authenticate the smartcard-smartjacket combination. If the authentication fails at 3A, it will lead to step 8. If the authentication passes at this point, there are two possible paths. If the Smartcard and smartjacket are being used for the first time and this is the initial user activation, it will pair with the smartmobile app to undergo steps a, b and c. Fail has two outcomes; one initiates subprocess 1B and one that deletes the content of SE. If the authentication of mobile with jacket fails, deleting the content of SE will be an extreme step. An appropriate message will be send on the mobile UI and the flow should go back to step 5 (or Path 1). This subprocess is a secondary route in case of failure in step b and can either lead to card activation, smartcard data deletion or the smartcard ecosystem locking the user out temporarily. However, if the user has already completed the initial pairing, the process will move to step 5 and 6 allowing the user to complete the transaction at the POS.

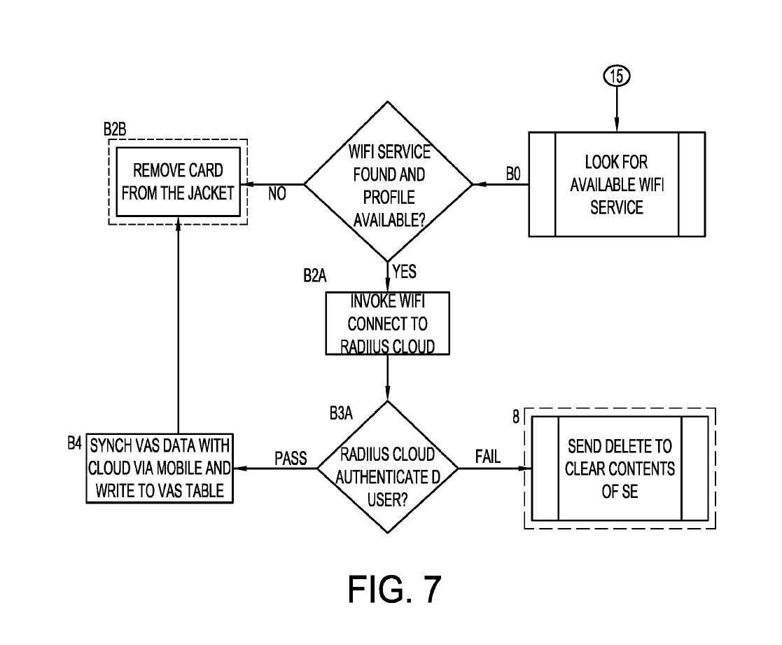

Subprocess 1B, shown FIG. 7 shows a non-limiting course of action for WiFi access to access the smartcloud system using the smartjacket and the failure of authentication. By default, the process begins at BO which looks for a usable WiFi network. If there is no network found, the path moves to B2B and the card becomes unusable for the moment. If a WiFi network is found and actively usable, the smartjacket connects to the smartcloud and attempts to authenticate the user at B3A. If the user cannot be authenticated, it leads to step 8. If the user can be authenticated, it leads to B2B where the user may remove the card from the jacket for use.

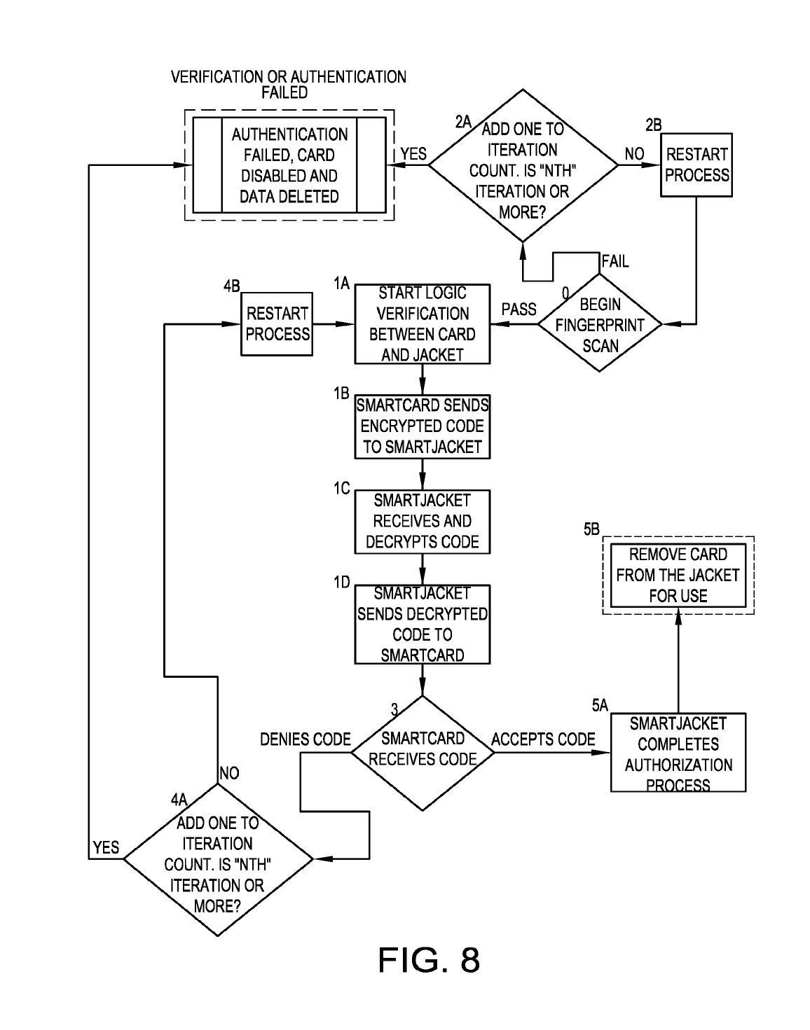

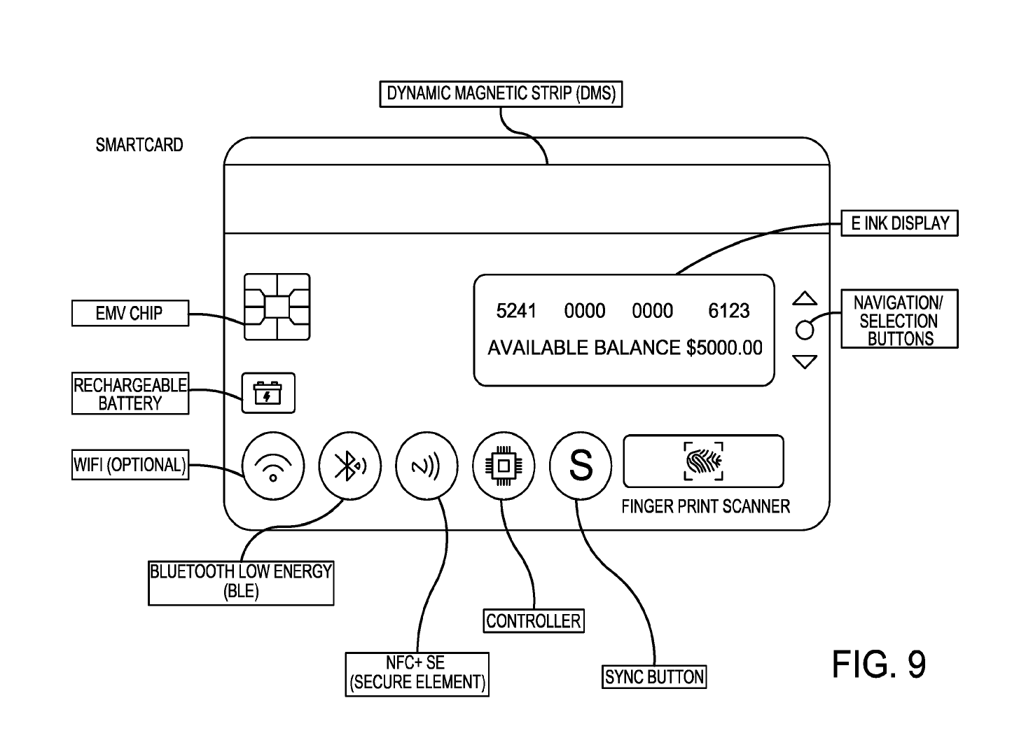

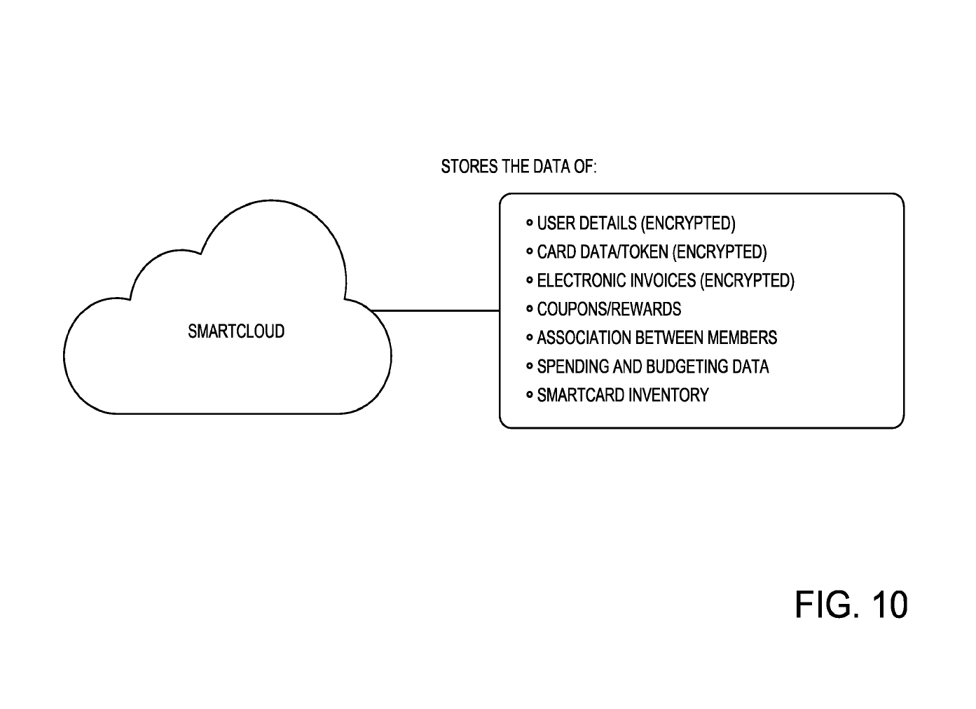

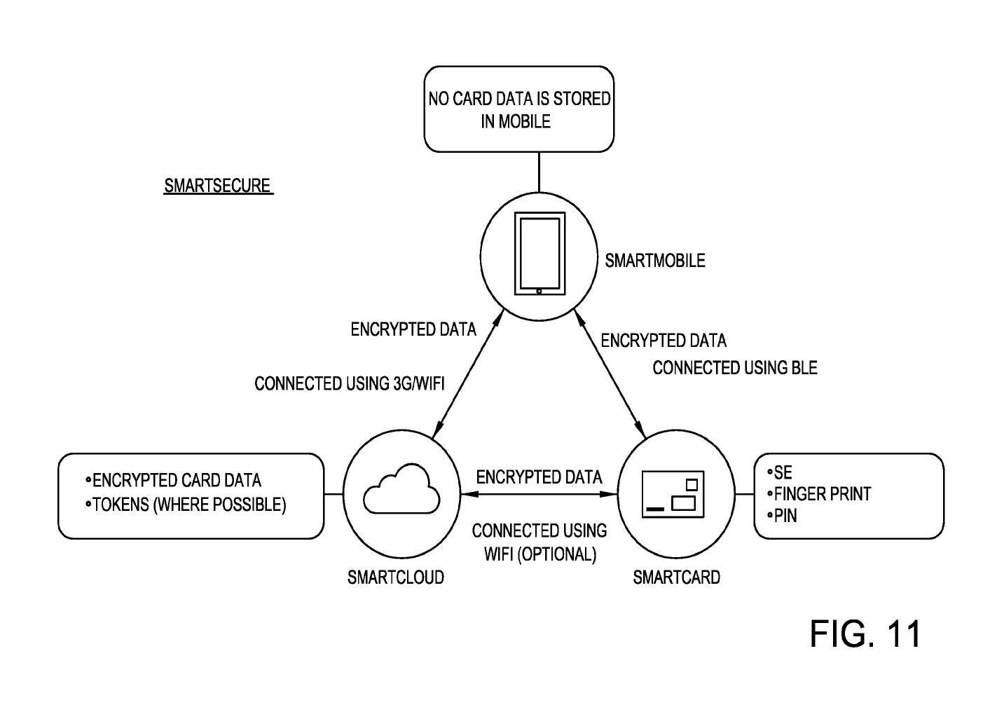

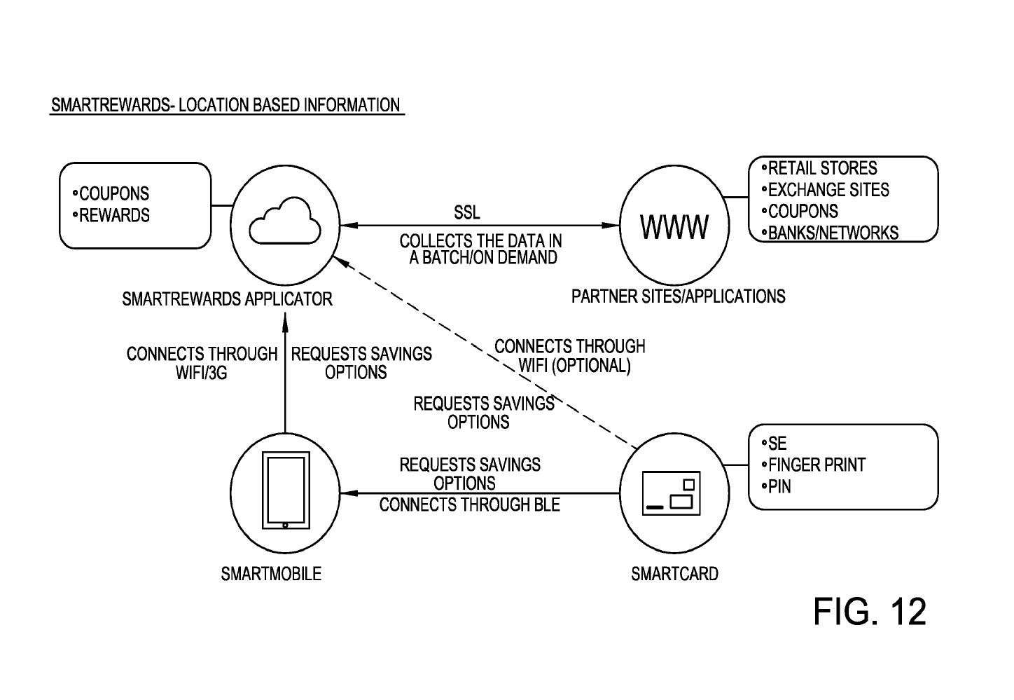

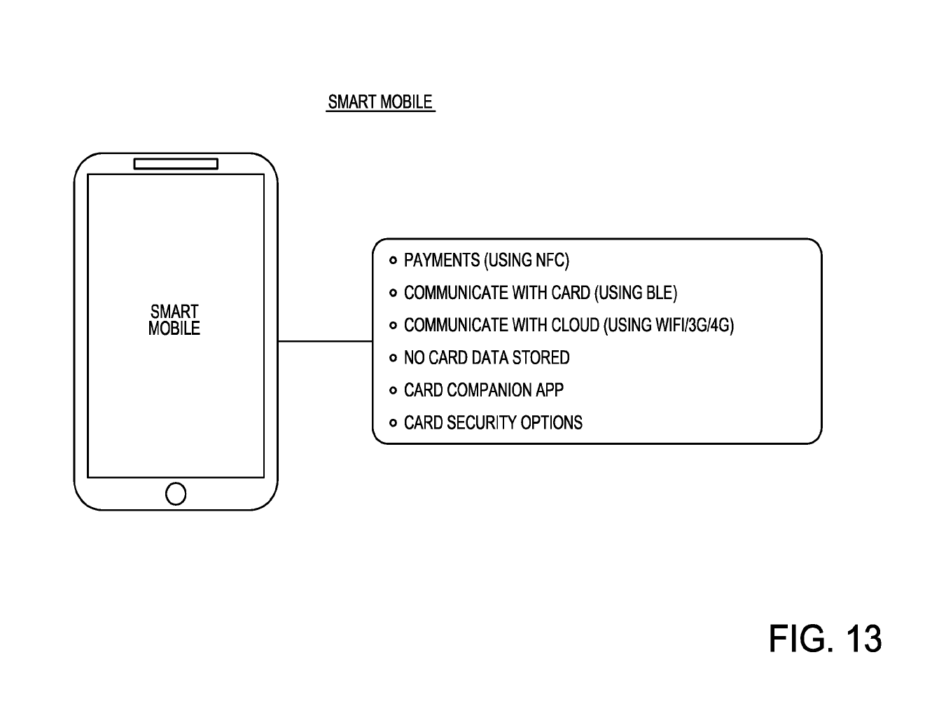

Now referring to FIG. 8, in one embodiment of the present disclosure FIG. 8 gives an overview of the logical verification of the smartcard in parallel with the physical verification for authentication of use. FIG. 8 outlines the logical and biometric verification and authentication process. The two work in parallel to one another and must both work in order to allow card use. Starting at point 0, the fingerprint scan begins. If the scan fails then the iteration count adds one. Once the count reaches “n” times, then the process moves directly to step 6 where the authentication fails and the smartcard and smartjacket are both locked from use. However, if there are less than n tries on the count, the process retries. Assuming the fingerprint passes, the main path which remains is 1. 1A to 1D illustrate the encryption send and receive method, all of which are dependent on the Jacket. Jacket MCU generates a random number. This number and card key on the Jacket is combined to create a session key in jacket SE. Jacket SE encrypts its identifier (Jacket-hash) with the session key as a response. Jacket MCU now sends the encrypted (Jacket-hash) along with random number to card SE. Card SE is able to generate the same session key using random number and card key. Card SE decrypts the (Jacket-hash) and compares with the value stored in card. If successful, the jacket is authenticated by the card. As a response, card sends the (card-hash) encrypting it with session key. Jacket MCU now sends the encrypted (card-hash) along with random number to jacket SE. Jacket SE decrypts the (card-hash) and compares with the value stored in card. If successful, the card is authenticated by the jacket. Should the card deny the code received, a process similar to 2A will occur based on the count relative to n tries. This will either lead to step 6 being put into action or a retry through path 4B. However, if the card accepts the code, it may safely be removed from the jacket and used at the POS.

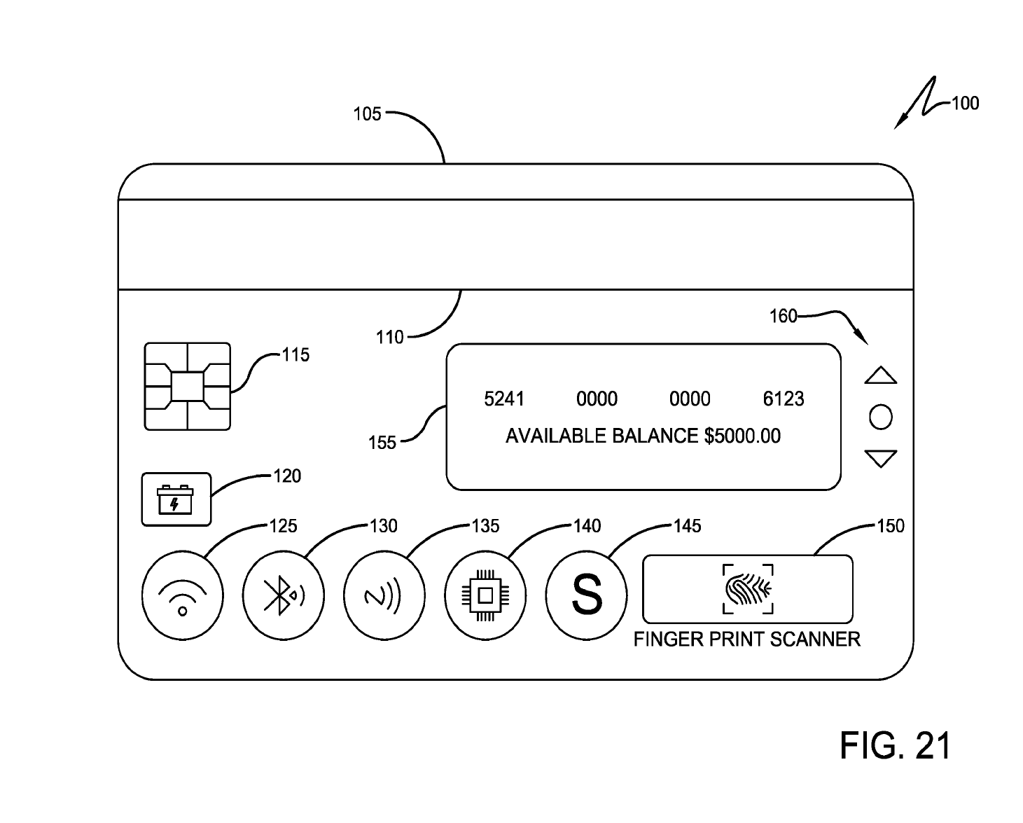

Since currently-available payment systems are deficient, a smart-card payment system that facilitates use of a plurality of payment cards, membership cards and coupons can prove desirable and provide a basis for a wide range of applications, such as purchasing of various goods and services at retail locations. This result can be achieved, according to one embodiment disclosed herein, by a smart-card 100 as illustrated in FIG. 21.

Turning to FIG. 21, the smart-card 100 is shown as comprising a card body 105 that includes a magnetic strip 110, an EMV chip 115, a battery 120, a Wi-Fi module 125, a Bluetooth module 130, a near field communication (NFC) module 135, a controller 140, a sync button 145, a finger print scanner 150, a display 155 and a button input 160. In various embodiments, the card body 105 can include a memory for storing various types of data.

The card body 105 can be any suitable shape and size in various embodiments. The card body 105 can also comprise any suitable material. For example, in some embodiments the card body 105 can conform to ISO/IEC 7810 identification card specification, including ID-000, ID-1, ID-2, ID-3 and the like. Accordingly, in some embodiments, the card body 105 can have a thickness of less than 1 mm, preferably less than 0.76 mm. Further embodiments need not conform to a standardized form factor or material specification.

The smart-card 100 can comprise one or more suitable communication module configured for various desirable wireless, wired, and/or contact-based communications or data transfers. For example, the embodiment illustrated in FIG. 1 comprises a magnetic strip 110, an EMV chip 115, a Wi-Fi module 125, a Bluetooth module 130, and a NFC module 135.

The smart-card 100 can comprise one or more suitable display 155, which can include a segment display, a screen, a light-emitting diode (LED), or the like. In some embodiments, such the display 155 can be touch sensitive. One or more display 155 can cover any suitable portion of one or more face of the card body 105. The display 115 can be configured to present text, images, video, or the like, in various embodiments.

The smart-card 100 can comprise one or more suitable inputs in various embodiments. For example, the embodiment shown in FIG. 1 includes the sync button 145 and button input 160. In further embodiments, an input can comprise any suitable number of buttons, a touch screen, a capacitive touch input, or the like.

As discussed in more detail herein, the smart-card 100 can store data such as credit card numbers, account numbers, user names, passwords, coupons, and the like. The display 155 and one or more inputs can be used to view, select, update, edit and otherwise interact with such data in various ways as described herein.

The smart-card 100 can comprise one or more suitable biometric scanner, which as illustrated in FIG. 1 can include a finger print scanner 150. In some embodiments, the finger print scanner 150 can be used as or comprise an input or display. In further embodiments, such a biometric scanner can comprise a retinal scanner, a face scanner, a DNA scanner, or the like.

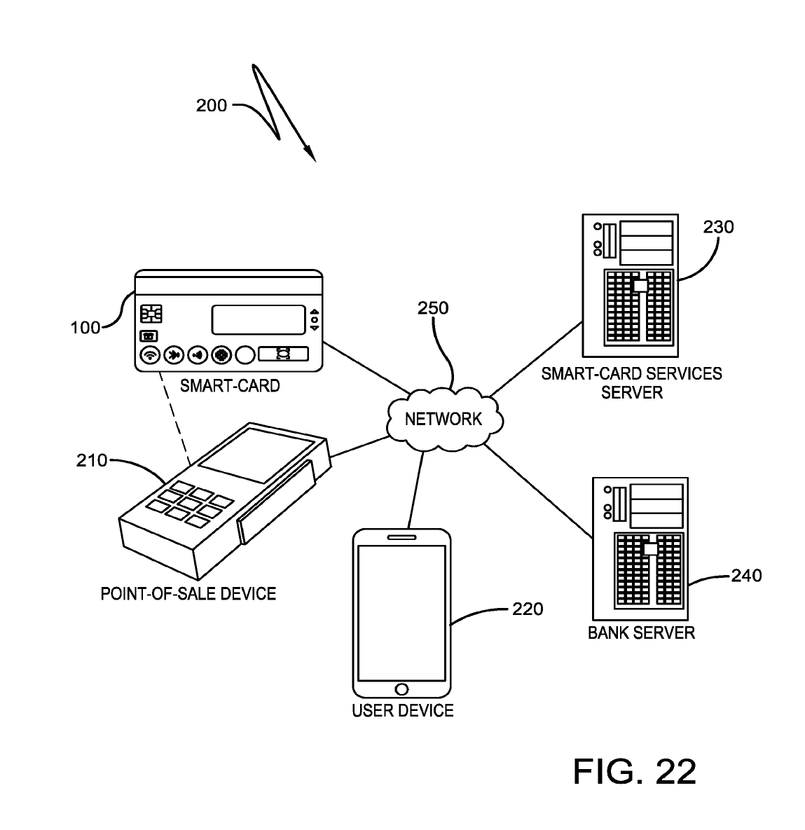

Turning to FIG. 22, a smart-card payment system 200 is illustrated that comprises the smart-card 100 of FIG. 21. The smart-card payment system 200 also comprises a point-of-sale (POS) device 210, a user device 220, a smart-card services server 230, and a bank server 240, which can be operably connected via a network 250. Additionally, in various embodiments, the smart-card 100 can be configured to communicate with the POS device 210 outside of the network 205, as discussed in more detail herein, which is illustrated in FIG. 22 by a dashed line.

In various embodiments, the network 250 can comprise any suitable wired and/or wireless network, including a Wi-Fi network, the Internet, a cellular network, a Bluetooth network, an NFC network, a local area network (LAN), a wide area network (WAN), or the like.

Although the POS device 210 is illustrated as a card reader device and the user device 220 is illustrated as a smartphone, these examples should not be construed to limit the many devices that can comprise such devices 210, 220 in accordance with various embodiments. For example, in further embodiments, such devices 220 can comprise a smartwatch, a headset computer, a tablet computer, a smartphone, a laptop computer, a desktop computer, a gaming device, a camera, or the like. Additionally, although the POS device 210 is illustrated as comprising a magnetic strip reader, in various embodiments, such hardware can be absent as discussed herein.

Similarly, the servers 230, 240 can comprise any suitable server system having one or more devices. In various embodiments, one or both of the servers 230, 240 can comprise cloud-based server systems.

In further embodiments, and as discussed herein, in some embodiments, any of the devices 210, 220 or servers 230, 240 can be absent or present in a plurality. For example, in one preferred embodiment, there can be a plurality of users that are each associated with a smart-card 100 and one or more user device 220. The users can shop or otherwise transact business at a plurality of business establishments that each have at least one POS device 210, and the users can facilitate various transactions with a given business establishment using such a POS device 210 and the user's smart-card 100 and one or more user device 220. Examples of such transactions are illustrated in FIGS. 3-6.

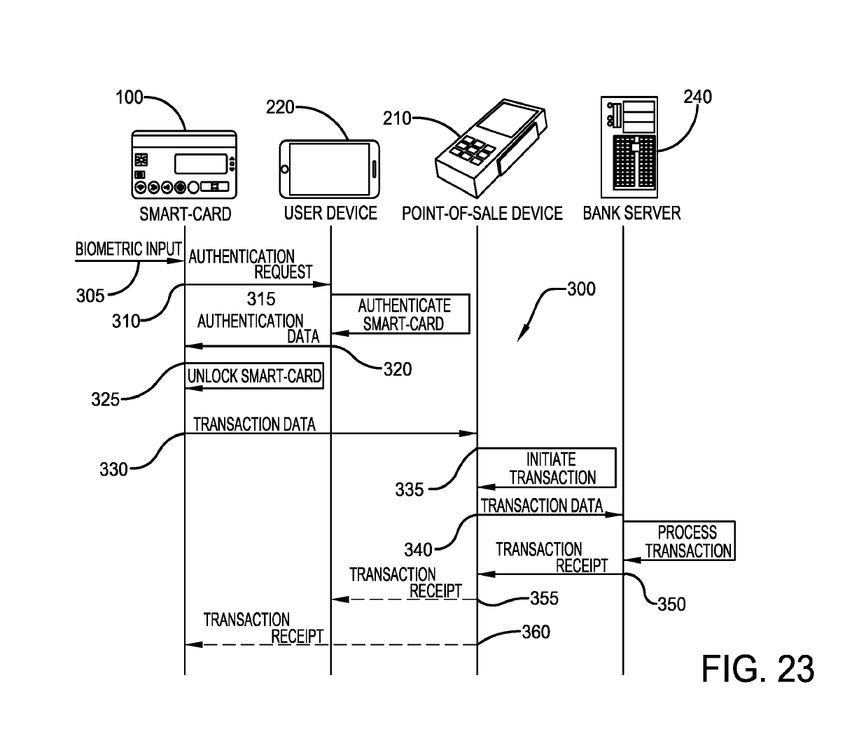

Turning to FIG. 23, in one embodiment, a transaction can comprise communications 300 between the smart-card 100, user device 220, POS device 210, and the bank server 240. At 305, biometric input is received at the smart-card 100 and an authentication request is sent to the user device 220, at 310. At 315, the smart-card is authenticated, and at 320, authentication data is sent back to the smart-card 100, where the smart-card 100 is unlocked.

For example, in various embodiments, it can be desirable to provide enhanced security for use of the smart-card 100 by requiring a biometric input and authentication by a registered user device 220 that is proximate to the smart-card 100. This can be desirable because it can ensure that only a valid user of the smart-card 100 can use the smart-card 100 when a registered user device 220 is proximate to the smart-card 100 and the valid user provides an authenticating biometric input.

For example, in one embodiment, a user can swipe a finger on the finger print scanner 150 on the smart-card 100 and the smart-card 100 can be authenticated by the user device 220 before the smart-card 100 becomes unlocked and usable for transactions. In various embodiments, authentication between the smart-card 100 and user device 100 can be via a close-range communication method such as NFC and/or Bluetooth so that unlocking the smart-card 100 is predicated on relatively close proximity to the user device 220.

Authentication can be via any suitable method, and in some embodiments, simply establishing a network connection or pairing of the smart-card 100 and user device 220 can be sufficient for authentication to unlock the smart-card 100. In some embodiments, such authentication can occur via only communication between the smart-card 100 and user device 220; however, in further embodiments authentication can involve other devices or servers, including the smart-card services server 230.

In various embodiments, authentication or pairing must occur with a registered user device 220. For example, a user can setup an account associated with the smart-card 100 in various suitable ways and such an account setup can comprise associating one or more specific user device 220 with the account. Such association can include various suitable identifiers, including a medium access control (MAC) address, a device name, a user name, a password, or the like.

Returning to the communications 300 of FIG. 23, at 330, transaction data is received by the POS device 210, where a transaction is initiated, at 335. Transaction data is sent to the bank server 240, at 340, where the transaction is processed, at 345. At 350, a transaction receipt is sent to the POS device 210. In some embodiments, a transaction receipt can be sent to the smart-card 100 and/or user device 220, at 355 and 360.

For example, in one embodiment, the smart-card 100 can be unlocked and used in a business transaction much like a credit card, debit card, gift card, member card, or the like. The smart-card 100 can be swiped at the POS device 210 to obtain transaction data (e.g., a credit card number, debit card number, gift card number, member number, or the like). Alternatively, and/or in addition to transaction data being provided to the POS device 210 via the magnetic strip 110, in other embodiments, transaction data can be provided via any of the EMV chip 115, a Wi-Fi module 125, a Bluetooth module 130, and a near field communication (NFC) module 135, or the like. In some embodiments, a cashier can input such transaction data into the POS device 210 manually via an input on the POS device 210.

In some embodiments, a plurality of cards and/or coupons can be used in a given transaction, either as a group or in succession. In one example transaction, a user can provide via the smart-card 100 a membership card to obtain a first discount, a coupon to obtain a second discount, a gift card to pay for a first portion of a fee, and a credit card to pay for a remainder portion of the fee. Accordingly, various embodiments can provide the benefit of using multiple payment cards, membership cards and/or coupons without having to carry a plurality of such cards or coupons.

Although FIG. 23 illustrates one transaction that involves a bank server 240, in further embodiments, and in other types of transactions, interaction with a bank server 240 may not be necessary. For example, some transactions may only require processing via the POS device 210, a server associated with the business, the smart-card services server 230, or the like. Accordingly, various transactions can comprise payment via credit, cash, electronic currency, payment token, or the like.

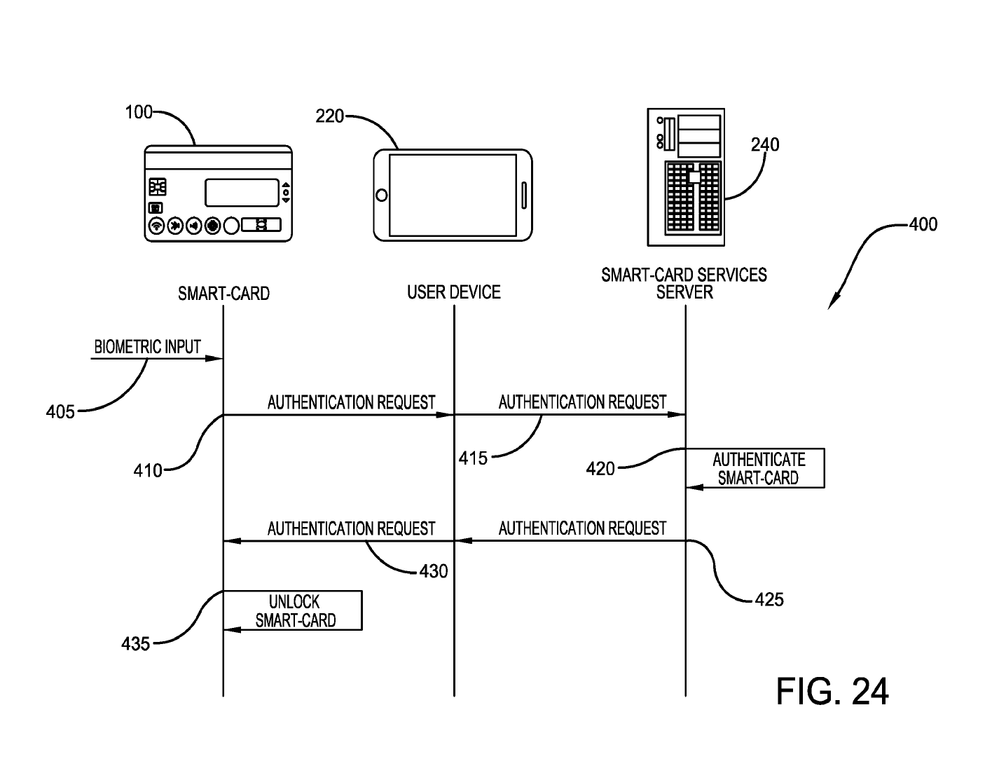

Turning to FIG. 24, in some embodiments, authentication and unlocking of a smart-card 100 can comprise communication with a user device 220 and card services server 230. As illustrated in the example communications 400 of FIG. 4, at 405, a biometric input can be provided to the smart-card 100, and an authentication request can be sent to the user device 220, at 410. The user device 220 can send an authentication request to the smart-card services server 230, at 215, where the smart-card 100 is authenticated. At 425, authentication data is sent to the user device 220 and authentication data is sent to the smart-card 100, which can allow the smart-card to be unlocked at 435.

In various embodiments, it can be desirable for no sensitive data to be stored on the user device 220 and for such data to be exclusively stored on the smart-card 100. For example, in some embodiments, data such as credit card data, debit card data, or the like, can be stored on the smart card 100 and not stored on the user device 220. This can be desirable because, while the user device 220 can offer an extra layer of security by being required for unlocking the smart-card 100, the user device 220 does not store sensitive data such that it provides another source of such data that can be compromised. In some embodiments, the user device 220 application does not store any card data and only temporarily brings data on demand from the smart-card services server 230.

In one alternative embodiment, such authentication can occur directly between the smart-card services server 230 and the smart-card 100, without the user device 220 as an intermediary. In various embodiments, one or more user authentication method can be used or a user authentication method can be absent and the smart-card 100 need not be unlocked for use in a transaction. In further embodiments, unlocking the smart-card 100 can occur without the user device 220 and/or smart-card services server 230.

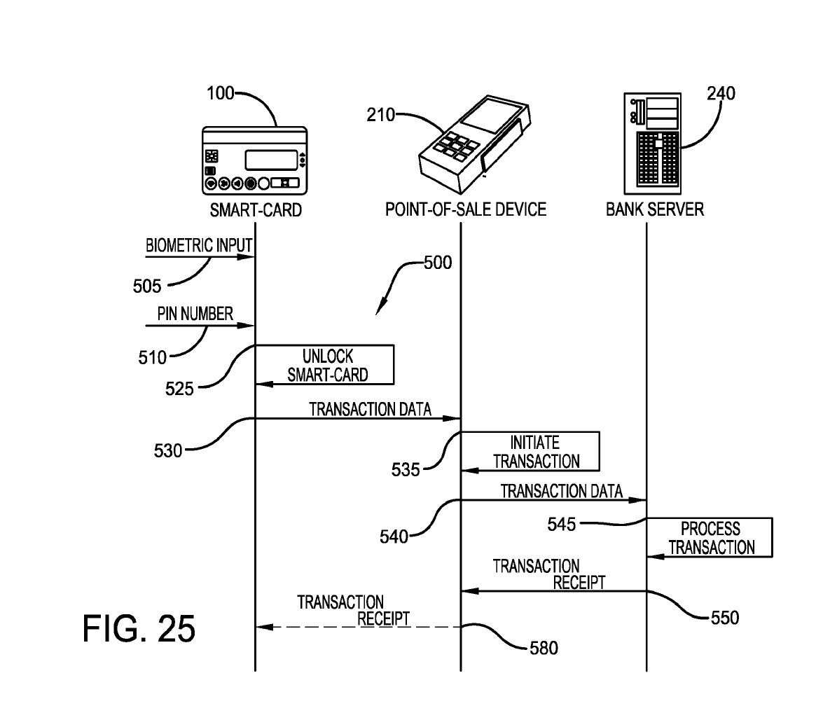

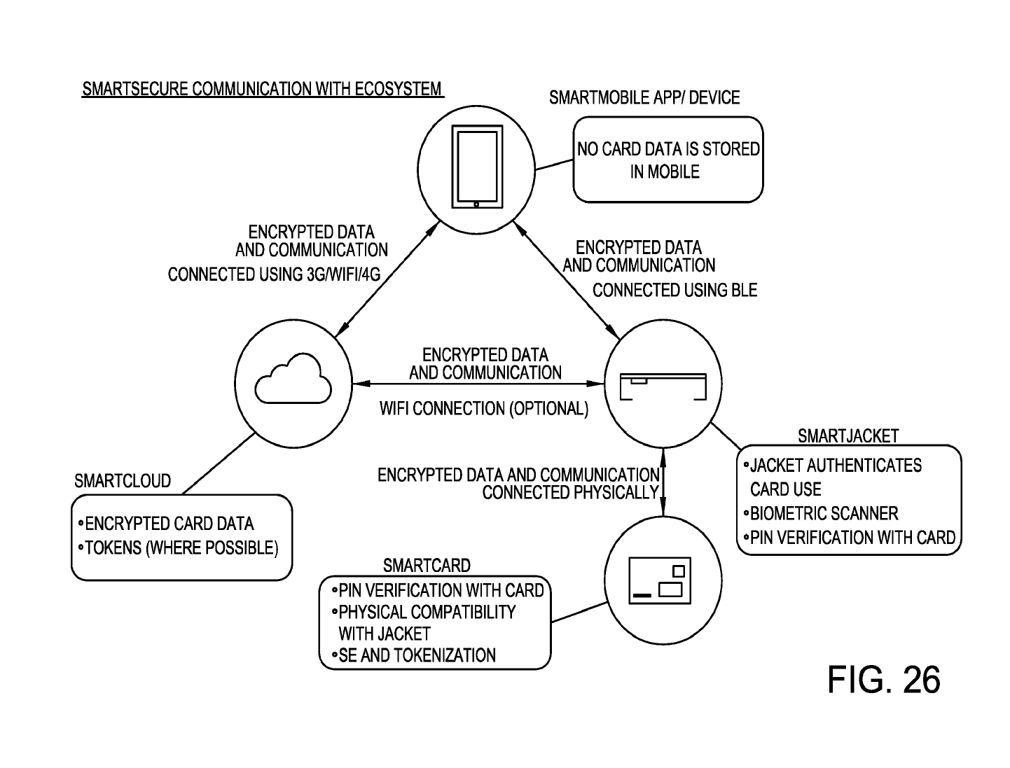

For example, referring to FIG. 25, in on example embodiment, a biometric input is received by the smart-card 100, at 505, and a pin number 510 is received, at 510. The smart-card is then unlocked, at 525. At 530, transaction data is received by the POS device 210, where a transaction is initiated, at 535. Transaction data is sent to the bank server 240, at 540, where the transaction is processed, at 545. At 550, a transaction receipt is sent to the POS device 210. In some embodiments, a transaction receipt can be sent to the smart-card 100, at 360.

Although the example of FIG. 25 illustrates both a biometric input and pin number being provided to unlock the smart-card 100, in some embodiments, only a biometric input is provided, or only a pin number is provided to unlock the smart-card 100.

Now referring to FIG. 22, additionally, although various embodiments describe a smart-card 100 being used in various transactions, in further embodiments, the user device 220 can be configured to perform some or all of the functions of a smart-card 100 as described herein. In some embodiments, the user device 220 can use conventional hardware and/or software to achieve such functionalities and/or can use peripherals to achieve such functionalities (e.g., a magnetic strip peripheral, or the like).

In various embodiments, coupons can be obtained and stored by the smart-card 100. For example, coupons can include various offers, discounts, or the like, that relate to goods and/or services. Coupons can include a percentage discount off a total bill, percentage discount off a given item, a rebate, a buy-one-get-one-free deal, a financing offer, a loyalty or rewards membership coupon, or the like. As discussed herein, such coupons can also be applied, used, or otherwise exploited using the smart-card 100 during a transaction.

In various embodiments, coupons can be selectively delivered to the smart-card 100. For example, selective delivery can include delivery based on a rewards membership; a loyalty membership; a location of the smart-card 100 and/or user device 220; transaction history of a user associated with the smart-card 100, or the like. In some embodiments, coupons can be updated on the smart-card 100 automatically, without user interaction, or can be updated selectively by the user. For example, a user can push the sync button 145 on the smart-card 100, which can initiate coupon updates.

In some embodiments, the smart-card 100 and/or user device 220 can be configured to scan, coupons, bar codes or the like, as an input method. In further embodiments, coupons can be added from a website, emails or other apps. In still further embodiments, partner merchants, retailers, e-retailers, airlines and other service providers can provide an interface that comprises a button to add an offer or coupon to the smart-card 100 and/or user device 220.

In various embodiments, a user can receive suggestions of one or more card and/or coupon to use in a given transaction. For example, presume that a user is buying a product at a given store. Based on a set of cards, coupons and the like associated with the smart-card 100, the user can receive a suggestion of what coupon(s) or offer(s) to apply to a card and/or what card(s) to use for payment based on criteria such as maximum total amount of savings, maximum rewards or loyalty points or benefits earned, lowest financing cost, best insurance terms, best return policy, available credit, available cash or available tokens, or the like.

As an example, where a user desires to receive the greatest discount for an item being purchased, a recommendation can be provided to use a store membership card, a store coupon, and a credit card that provides a cash rebate for the type of item being purchased. In various embodiments, the smart-card 100 and/or user device 220 can indicate a set of one or more cards, coupons, or the like, to be used. In some embodiments, the smart-card 100 and/or user device 220 can also indicate an order in which to use such cards, coupons, or the like that are part of a suggested set.

In some embodiments, the smart-card 100 and/or user device 220 can streamline a purchase using a plurality of such cards, coupons, or the like. For example, in contrast to swiping the smart-card 100 multiple times to use a plurality of cards, coupons, or the like, the smart-card 100 can facilitate transmittal of transaction data in a single swipe associated with each of the plurality of cards, coupons, or the like, in a suggested set. Such an embodiment can be desirable by making such transactions substantially easier and faster for both cashiers and users.

In various embodiments, the smart-card 100 and/or user device 220 can comprise various functionalities that allow a user to track and control spending and/or payment of various accounts associated with the smart-card 100. For example, the smart-card 100 and/or user device 220 can facilitate spending aggregation, analysis and tools for budgeting and setting spending targets which can be sent to the smart-card 100 so that the consumer is aware of spending targets for each card at the time of making payments.

Additionally, various embodiments provide for the smart-card 100 and/or user device 220 being configured for consumer registration, payment, updating and addition/deletion/updating of data cards, and the like. In other embodiments, the smart-card 100 and/or user device 220 can be configured for acquiring, storing and provisioning coupons/offers based on the location of the smart-card 100 and/or user device 220.

In still further embodiments, the smart-card 100 and/or user device 220 can be configured for facilitating synchronizing a portion of data stored on the smart-card 100 and/or user device 220. In some embodiments, the smart-card 100 and/or user device 220 can check with a token service provider (TSP) to determine whether an issuing bank supports payment tokens, and if so the smart-card 100 and/or user device 220 can request tokens and can store these instead of the card details.

In various embodiments, a system security platform can be built on open-source security standards that cover the security of data on some or all elements of the system 200. Such a system security platform can provide for communications between system devices and/or servers that are encrypted end-to-end using strong symmetric keys, or the like.

In various embodiments, the smart-card services server 230 stores all card data and personally identifiable consumer data in a secure encrypted form. In various embodiments, some or all communications within the system are encrypted end-to-end. The encryption can use AES with a minimum key length of 192 bits, a SHA 512 hash algorithm, or the like. In some embodiments, data can only be decrypted by the user directly by logging on to a smart-card services server 230 and/or on the request of the user device 220 and/or smart-card 100 once the user has authenticated himself.

Some embodiments provide for remotely wiping out data stored on the smart-card 100 via a request from the smart-card services server 230 or user device 220. As discussed herein, the smart-card 100 can be protected by a biometric scanning device and can store all data internally on a secure storage medium. In some embodiments, the user device 220 and/or smart-card 100 does not store any card data and instead fetches such data from the smart-card services server 230 at the time of transaction. In further embodiments, the smart-card services server 230, user device 220 and/or smart-card 100 can store payment tokens instead of payment cards.

In various embodiments, the smart-card 100 can automatically lock after a defined time period of inactivity. For example, in one preferred embodiment, after 150 seconds, the smart-card 100 enters the sleep or locked state automatically.

In one embodiment the smart-card 100 comprises a microprocessor or microcontroller to control other components on the smart-card 100 and to transfer data between components on the smart-card 100 and the external world; a dynamic magnetic stripe emulator to carry out payment/reward transactions using a magnetic card reader; and a Bluetooth smart chip for low energy data transfer between the smart-card 100 and other trusted mobile devices (e.g. the user device 220).

This example embodiment of the smart-card 100 further comprises an NFC chip to enable contactless EMV payments using payment tokens, or the like; a secure element for storing card data or payment tokens as appropriate; a rechargeable battery with an external wireless charger; an e-ink display for displaying information of one or more card or coupon at a time; buttons for navigating between stored cards/coupons, selecting a card/coupon and synchronizing with cloud and mobile applications; biometric scanner to switch on the smart-card 100; and low power Wi-Fi chip or 2G radio to directly connect to cloud applications.

In some embodiments, the smart-card 100 is operable to directly connect to cloud applications without the help of a mobile device. Alternatively, in further embodiments, if there is no Wi-Fi or 2G signal, the smart-card 100 can still connect to the cloud applications using the user device 220, a Bluetooth dongle connected to a computer, or the like. In various embodiments, the actual path chosen by the smart-card 100 to synch with the cloud is transparent to the user.

In one embodiment, creating a user account includes visiting a registration web page, which can be a secure transaction processing site. User completes online registration for a smart-card 100 by creating user id and password and by providing identifying credentials selected from phone number, email id, or the like. User updates other personal details like family relationships that can be stored in the smart-card 100 when shipped to the user. The user can add non-card information at this point. Actual card data can be entered using the smart-card 100 once the user receives the smart-card 100. User creates a Personal Financial Manager profile to enable a secure cloud based personal financial application. User creates a profile for smart-card 100 usage and smart-card 100 data management preferences of one or more specific card. User authorizes a coupon platform to collect user coupons and offers directly from one or more merchant and/or issuing banks. User receives smart-card 100 via mail or pickup and activates it using an activation code that has been separately sent or received. User adds various cards such as credit or debit or pre-paid or loyalty or rewards to the smart-card 100 which can include input via the smart-card 100 and/or user device 220. The user device 220 synchronizes data stored on the smart-card 100 and the smart-card services server 230.

Ongoing updates can be used to update preferences and/or personal data, and the user can use the user device 220 and/or an interface of the smart-card services server 230 to update preferences. To access coupons on the smart-card 100, in some embodiment, the user first activates the smart-card 100 by using his fingerprint and then presses the synch button and relevant coupons are delivered to the smart-card 100. The user location and/or users past buying behavior can be used to deliver coupons and offers that are relevant.

In some embodiments, to delete or update a card on the smart-card 100, the user has to use the user device 220 or interface of the smart-card services server 230. Once the details are updated on the smart-card services server 230, the user can then synchronize the details with the smart-card 100 by unlocking the smart-card 100 and pressing the synch button.

In one embodiment, if the consumer loses the smart-card 100, he or she initiates a request for cancellation. A security application can send a kill request to disable the existing smart-card 100 via the user device 220, or the smart-card services server 230. The consumer can then pay a replacement fee and get a new smart-card 100. In various embodiments, there is no need for the consumer to report loss of any of his cards stored inside the smart-card 100. Where the smart-card 100 is protected by a biometric scanner and all the data is stored securely inside a secure element, no other person can access any data stored on the smart-card 100.

Various embodiments of the present disclosure are directed to a payment and reward ecosystem in an attempt to solve the problem of carrying multiple cards, dealing with reams of paper invoices, missed opportunities to save due to expired gift cards and coupons and an overload of information related to offers. Example embodiments of components and business processes embodied in the ecosystem that can help achieve this are described in the following paragraphs.

The term “SmartCard” as used herein, refers to a type of chip card, and can be a plastic card that can comprise an embedded computer chip, (a memory, microprocessor type, or the like) that stores and transacts data. This data can be associated with either value, information, or both and can be stored and processed within the card's chip. The card data can be shared with the external world through a reader or wirelessly using wireless protocols e.g. Bluetooth Smart, Near Field Communication (NFC), Wi-Fi, 2G (second generation radio modems), or the like.

In one embodiment, the present disclosure teaches a payment and rewards ecosystem comprising: a) SmartCard having form factor specified by ISO/IEC 7810 protected by a biometric scanner and can work independently of other components; b) SmartCloud based applications for registration, provisioning of SmartCards, spending analytics, budgeting tools and integration with partner systems; c) SmartSecure platform for the highest level of security across the ecosystem; d) SmartRewards applications for aggregation and dynamic delivery of rewards, coupons, offers and gift cards; and e) SmartMobile solution having an independent mobile payment solution and SmartCard helper solution. In various embodiments, SmartCard can be built on the principle of Internet of things, with a form factor defined in ISO/IEC 7810, and can replace all cards in a wallet, capture electronic point of sale data and acquire and apply real-time rewards, coupons and loyalty points at the point of transaction. In some embodiments, the SmartCard can have an e-ink low power display of 4 lines or more to show the details of each card stored inside the SmartCard. In further embodiments, the SmartCard can have buttons to navigate between the stored cards and to select one card. In addition, in other embodiments, the SmartCard can have a synch button to exchange data with the cloud and/or mobile applications.

In various embodiments, the SmartCard conforms to the ISO/IEC 7810 standard for physical characteristics like physical dimension, resistance to bending, flame, chemicals, temperature and humidity and toxicity. Accordingly, the inventive SmartCard can have a thickness of lower than 1 mm, preferably 0.76 mm. In various embodiments, the SmartCard includes one or more of the following components: a.) a Microprocessor or Microcontroller to control other components on the SmartCard and to transfer data between components on the SmartCard and the external world; b.) a dynamic magnetic stripe emulator to carry out payment/reward transactions using a magnetic card reader; c.) a Bluetooth smart chip for low energy data transfer between the SmartCard and other trusted mobile devices. In some embodiments, the SmartCard will use the SmartSecurity framework to determine which external device to trust. The SmartCard can connect to point-of-sale (POS) devices of retail partners over Bluetooth smart to collect electronic invoices; d.) an NFC chip to enable contactless EMV payments using payment tokens, or the like; e.) a secure element for storing card data or payment tokens as appropriate; f.) a rechargeable battery with an external wireless charger; g. an e-ink display for displaying information of one or more card or coupon at a time; h.) buttons for navigating between stored cards/coupons, selecting a card/coupon and synchronizing with cloud and mobile applications; i.) biometric scanner to switch on the SmartCard; and j.) low power Wi-Fi chip or 2G radio to directly connect to the cloud applications.

In some embodiments, the SmartCard is operable to directly connect to cloud applications without the help of a mobile device. Alternatively, in further embodiments, if there is no Wi-Fi or 2G signal, the SmartCard can still connect to the cloud applications using SmartMobile application, a Bluetooth dongle connected to a computer, or the like. In various embodiments, the actual path chosen by the SmartCard to synch with the cloud is transparent to the user.

In an embodiment, the SmartCard can be switched on using biometric authentication. If the consumer wants additional security, the SmartCard can be set to work only when the consumer mobile device is also paired, thus providing an additional layer of security.

In another embodiment, SmartCard can allow the consumer to select a card as a default payment card. This can speed up the payment process using the SmartCard.

In various embodiments the SmartCloud can comprise a set of secure applications on the cloud and perform one or more of the following functions: a) consumer registration, payment, updating and addition/deletion/updating of data cards, and the like; b) provisioning of the SmartCard as described in the above embodiment or any other embodiment; c) spending aggregation, analysis and tools for budgeting and setting spending targets which can be sent to the SmartCard so that the consumer is aware of spending targets for each card at the time of making payments; d) acquiring, storing and provisioning coupons/offers based on card/mobile device locations; e) data analytics to support Best-Card-to-Use and Dynamic Saving options based on card and partner offers; and f) synchronize results with SmartCard and SmartMobile device.

In some embodiments, the SmartCloud application for card data storage can check with a token service provider (TSP) to determine whether the issuing bank supports payment tokens. If the answer is yes, the SmartCloud can request tokens and can store these instead of the card details.

In various embodiments, the SmartSecure Platform can ensure security of data across the ecosystem. For example, in some embodiments, all communications within various elements of the ecosystem, viz. SmartCloud, SmartCard and SmartMobile can be encrypted end-to-end using keys generated uniquely for each consumer and SmartCard. The encryption can use AES with a minimum key length of 192 bits, or the like.

In various embodiments, the SmartCard can be dormant (inactive) until the consumer uses his fingerprint to activate the card. In addition, in some embodiments, all data inside the SmartCard resides in a secure element in an encrypted form. In addition, the SmartCard can store all data in the secure element for additional protection. For cards where payment tokens are supported, tokens can be stored instead of card data.

In various embodiments, no card data is stored on the mobile phone. For example, in such embodiments, for any transaction, SmartMobile device connects to the SmartCloud to get the card data for a particular transaction.

In various embodiments, the SmartCloud encrypts all card data and user identifiable data before storing using the SmartCard and consumer keys. In one embodiment, SmartCloud can use salting and SHA 512 as the hash algorithm. In some embodiments, this data can only be decrypted by the consumer directly by logging on to SmartCloud and/or on the request of SmartMobile/SmartCard once the user has authenticated himself.

In the event of a SmartCard getting lost, some embodiments of the SmartSecure platform can permanently disable the SmartCard through a remote command.

In various embodiments, the SmartRewards component can comprise a set of applications for rewards and coupons aggregation. SmartRewards can allow consumers to store and apply coupons, loyalty memberships, reward points, and the like, within a single application. The SmartRewards application can perform one or more of the following functions in various embodiments: a) stores loyalty & rewards membership—loyalty no. and required user authentication data; b) communicates with SmartCard and SmartMobile to update loyalty and rewards data; c) serves rewards & coupons based on location of SmartCard and SmartMobile; d) scans bar codes and upload coupons; e) adds coupons from a website, emails or other apps; f) Partner merchants, retailers, e-retailers, airlines and other service providers would carry a button to add an offer directly to SmartRewards; and g) exchanges rewards and coupons online.

Another embodiment includes a mobile application ecosystem to perform all the functions of SmartCard as described in the above embodiments, or other embodiments, except payment can be performed through a magnetic stripe reader. For example, in such embodiments, the SmartMobile application would be able to make payments over any NFC enabled POS, or the like. In some embodiments, the SmartMobile application does not store any card data and brings data on demand from the SmartCloud.

Accordingly, in various embodiments, the SmartMobile application acts as a helper application for the SmartCard by enabling connectivity to the cloud if the SmartCard cannot connect to the cloud. It can further provide an additional authentication layer for the SmartCard if the consumer so desires. Additionally, some embodiments of the SmartMobile enables the consumer to choose the appropriate card and synch the result to the SmartCard.

Accordingly, various embodiments of the inventive ecosystem provide the consumer with savings recommendations and options at the time of purchase. These include recommendations on Best-Card-to-Use, delivery of relevant location based coupons, offers, gift cards, and the like.

Other embodiments provide processes which work with components of the inventive ecosystem and provide services to the consumer. Various embodiments can include one or more of the following processes: User Creation, Ordering and Activation of Consumer Account and SmartCard.

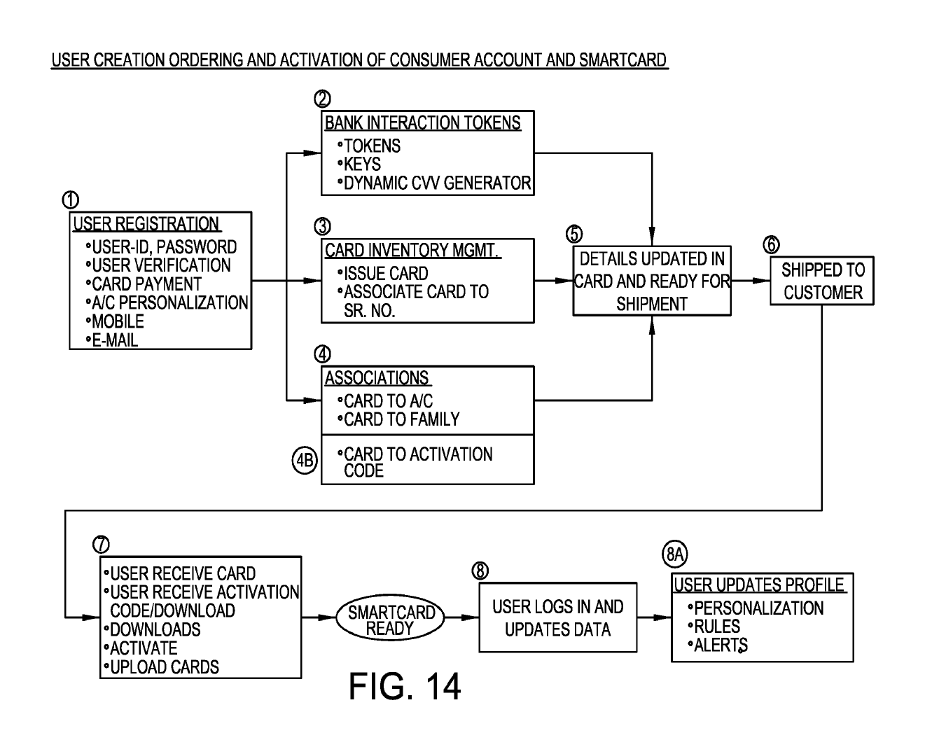

FIG. 14 outlines one non-limiting example of user creation, ordering and activation of a consumer account and smart card. The process commences where a user visits a SmartCloud registration web page, which can be a secure transaction processing site. User completes online registration for a SmartCard by creating user id and password and by providing identifying credentials selected from phone number, email id, or the like. User updates other personal details like family relationships that can be incorporated in the SmartCard when shipped to the user. The user can add all non-card information at this point. Actual card data can be entered using the SmartMobile once the user receives the SmartCard. User creates a Personal Financial Manager profile to ensure that the secure cloud based personal financial solution is enabled. User creates a profile for SmartCard usage and SmartCard data management preferences specific card. User authorizes the SmartRewards platform to collect user coupons and offers directly from the merchant and/or issuing banks. User receives SmartCard and activates it using an activation code that has been separately sent. Later User adds various cards such as credit or debit or pre-paid or loyalty or rewards to the SmartCard with the help of SmartMobile. SmartMobile synchronizes the data both with SmartCard and SmartCloud

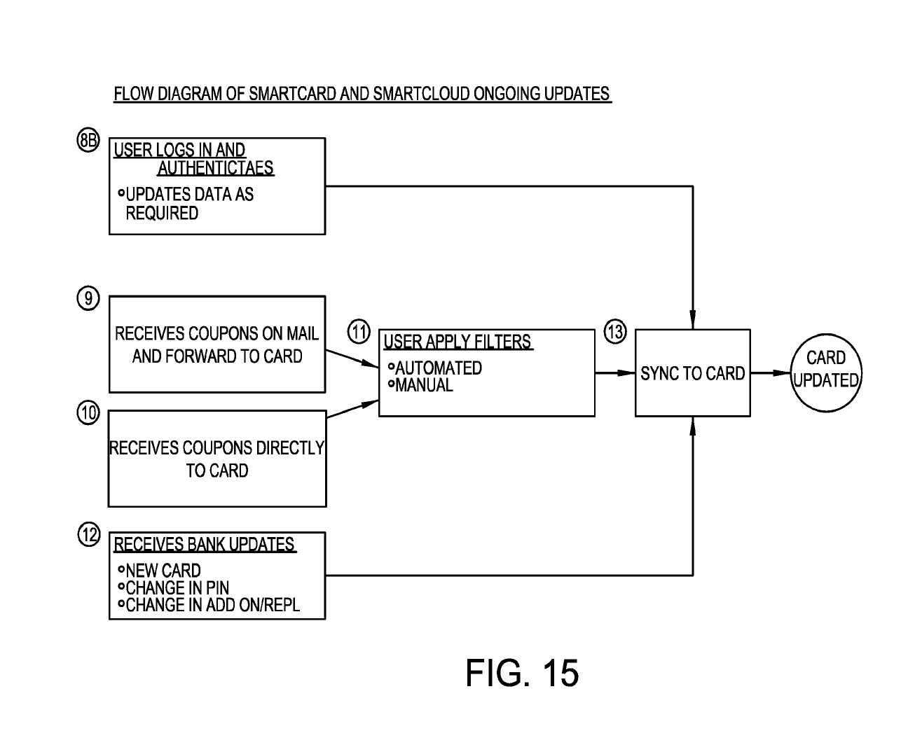

FIG. 15 outlines one non-limiting example of ongoing updates for SmartCloud and SmartCard in accordance with an embodiment. The ongoing updates process can be used to update preferences or personal data, and user can log in to SmartMobile or SmartCloud and update preferences. To access coupons on the SmartCard, the user first activates the SmartCard by using his fingerprint and then presses the synch button and the SmartRewards delivers relevant coupons to the SmartCard. The SmartRewards uses the user location and users past buying behaviour to deliver coupons and offers that are relevant. In some embodiments, to delete or update a card on the SmartCard, the user has to use the SmartMobile or SmartCloud application. Once the details are updated on the SmartCloud, the user can then synchronize the details with the SmartCard by activating the SmartCard and pressing the synch button.

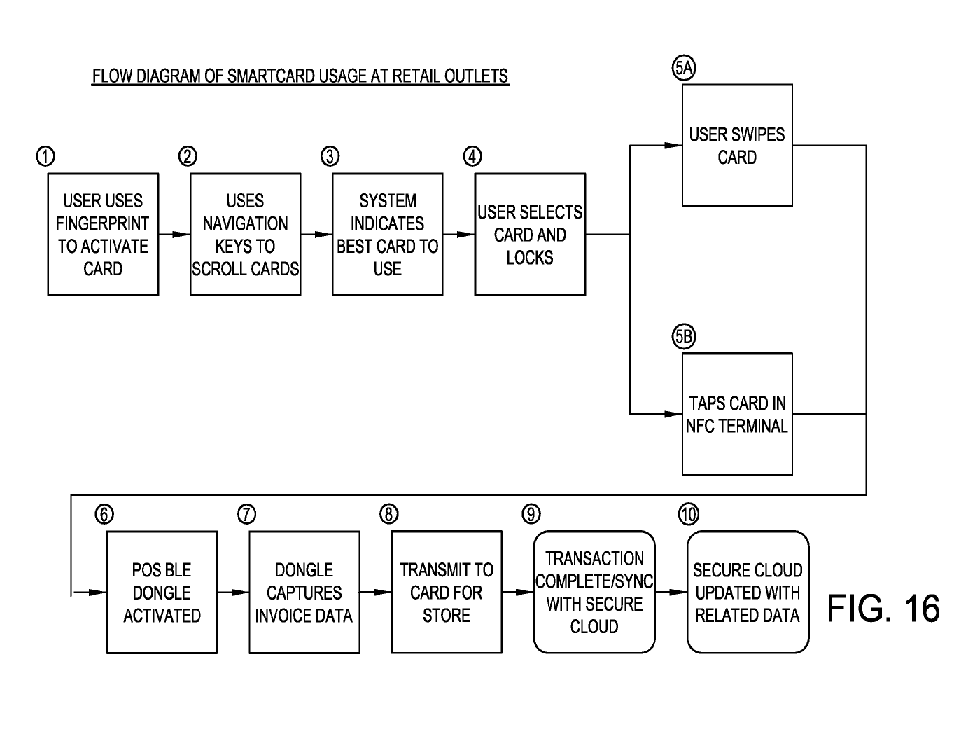

FIG. 16 outlines one non-limiting example of SmartCard usage at retail outlets in accordance with an embodiment. The process includes User activating card at Retail outlet using his fingerprint. If the user has enabled a two factor authentication, then the SmartCard can automatically pair with SmartMobile and get activated. In case SmartMobile is not available, the SmartCard can wait for the correct PIN to be entered. User optionally synchs SmartCard with SmartRewards and hands over card to billing clerk to apply coupons and discounts. Rewards card can be applied for the specific retailers/merchandisers as required. User chooses option to select payment mechanism selected from debit, credit, prepaid on e-paper display. User sees the available card—with updated balances on the e-paper display. User is also prompted for best card to use—either from static user preference settings created earlier or from the best card to use depending on the retailer or merchandise category—as specific to certain cards. This is notified through a symbol—denoting “Best card to use.” User selects and locks card and hands over to the billing clerk. The specific card is swiped or used for contactless EMV payment, as appropriate. If the POS system is capable of sending electronic invoices, the SmartCard can collect electronic invoices and store them. These can be sent to the SmartCloud the next time user presses the synch button. After 150 seconds, SmartCard enters the sleep state automatically.

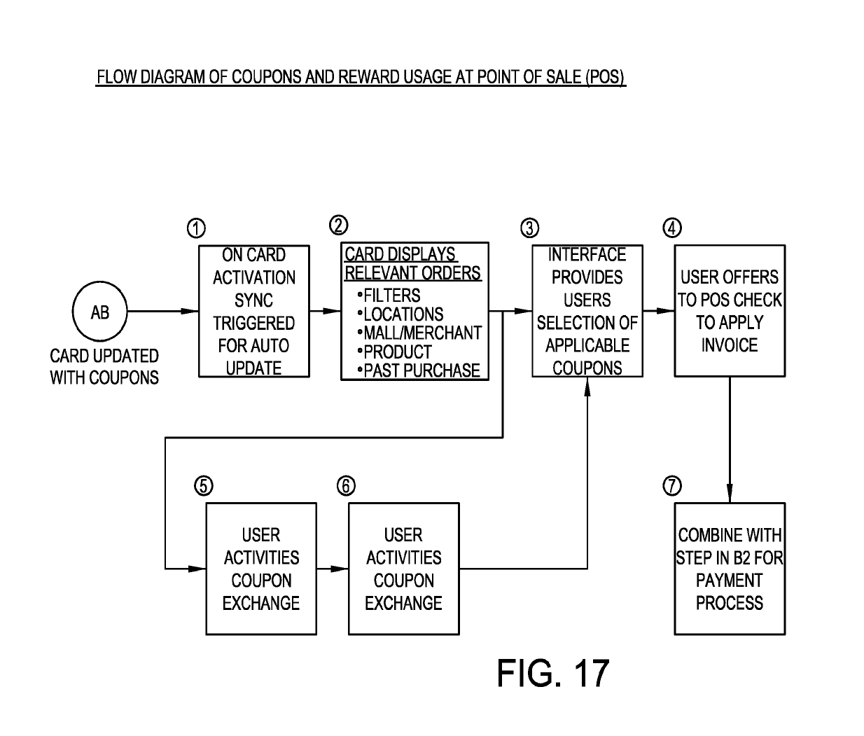

FIG. 17 outlines one non-limiting example of a process of coupons and rewards usage at Point-of-Sale (POS) terminal in accordance with an embodiment. This example process of using coupons already stored on a SmartCard includes: After activation of card user selects and locks one rewards card on e-paper display by toggling navigation keys (for up and down movement). User locks rewards card and hands over SmartCard to POS clerk for swiping. Once done user has option to use coupons on mobile or coupons loaded on card. Card displays Merchant code (offering coupon) and the coupon code (8-10 digit) and an offer summary (e.g. 20% discount). Member selects coupon and offer card to POS clerk again for applying coupon. POS clerk completes swipe and returns to card-holder. Card holder proceeds to select appropriate payment card, locks and swipes, enters in chip reader or brings card near NFC terminal to complete transaction.

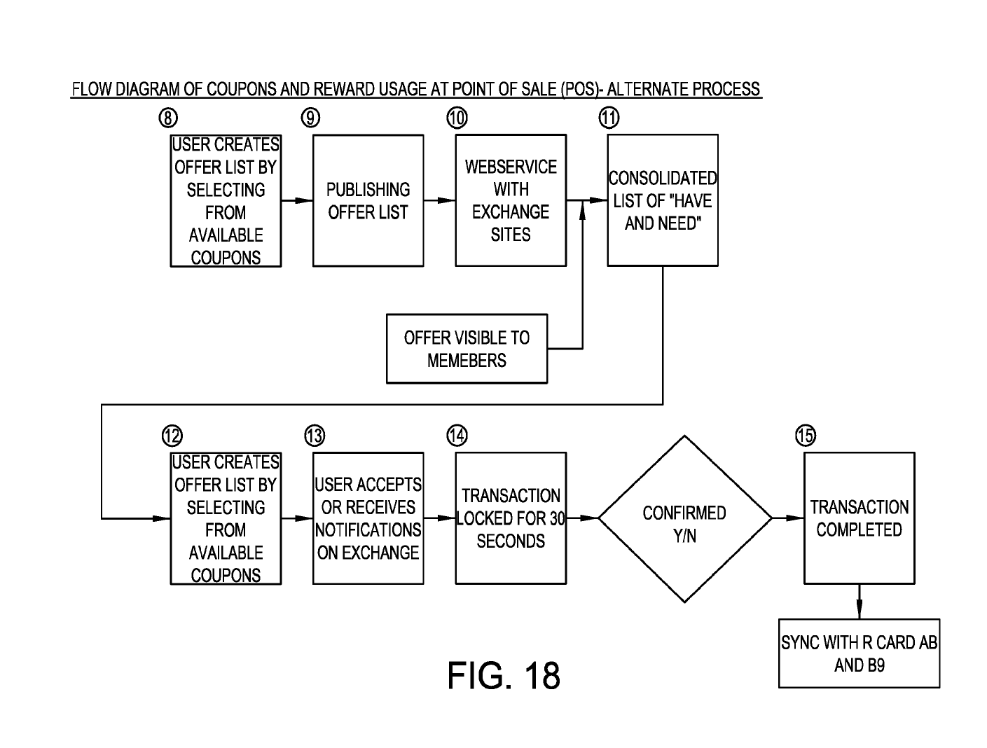

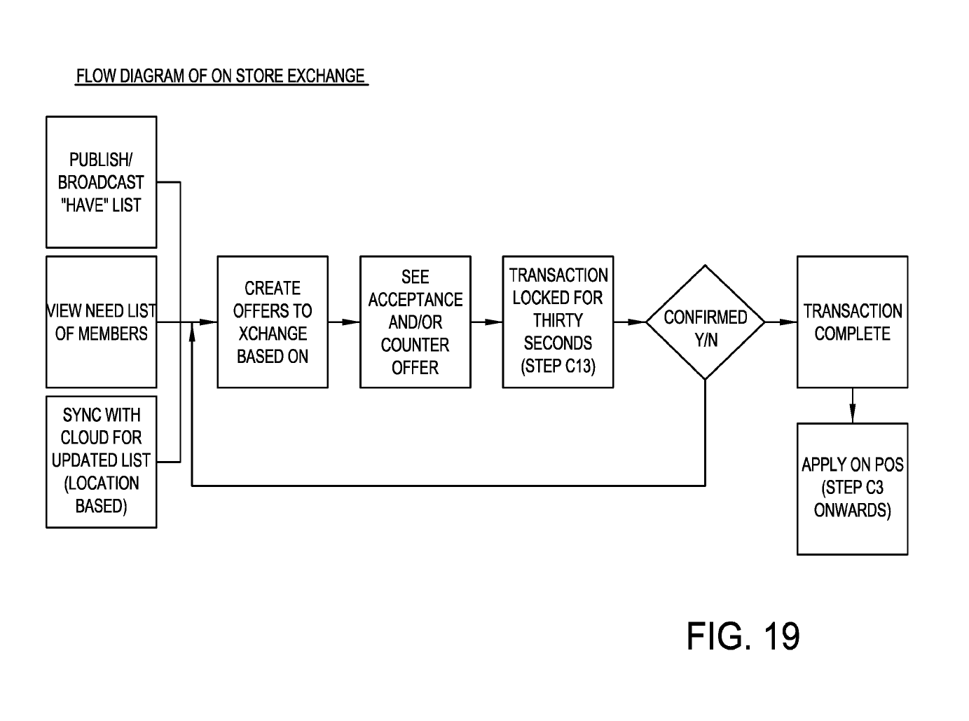

FIG. 18 outlines another non-limiting example of a process of coupons and rewards usage at point-of-sale terminal in accordance with an embodiment. This example process includes: User activating SmartCard and selecting “Coupon exchange” on e-paper display. User scrolls list of offers available with him/her and checks the coupons he/she would like to exchange. User selects option to view available offers as published by other SmartCard holders. User selects the offers that are of interest and creates a counter of his own coupons. User launches offer and publishes to SmartCard users. Once seller confirms the coupons are exchanged and the cards are updated with the latest coupon details.

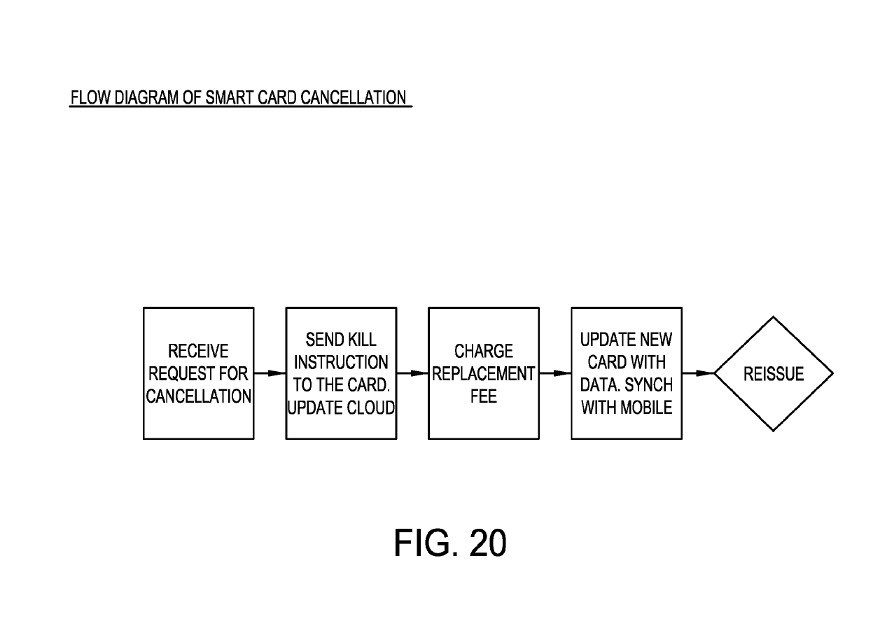

FIG. 20 outlines one non-limiting example of a process of cancellation of SmartCard in accordance with an embodiment. For example, if the consumer loses the SmartCard, he initiates a request for cancellation. SmartSecurity applications send a kill request to disable the existing SmartCard. The consumer can then pay a replacement fee and get a new SmartCard. In various embodiments, there is no need for the consumer to report loss of any of his cards stored inside the SmartCard. Where the SmartCard is protected by a biometric scanner and all the data is stored securely inside a secure element, no other person can access any data stored on the SmartCard.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A universal smartcard/smartjacket/wearable device comprising:
a.) a smartcard/device, assembly, wherein the smartcard comprises:
a secure element,
wherein the secure element of the universal smartcard comprises, one pre-loaded network applet per network, one pre-loaded payment system environment (PSE) and/or proximity payment system environment (PPSE) applet and one payment card applet per account stored on the smartcard,
wherein the payment card applet comprises card account information, tokens and card verification value (CVV) generators required by various networks,
wherein the PSE and/or PPSE applets allow or disallow a point of service terminal to access payment card applets depending on whether a payment card applet is unlocked or locked and wherein the PSE applets are for contact connected point of service terminals and the PPSE applets are for contactless point of service terminals
an optional display,
a rechargeable battery,
an EMV (Europay, Mastercard, Visa) chip to support a point of service terminal that accepts EMV chips,
a Near Field Communication chip (NFC) to support a point of service terminal that accepts NFC chips,
a magnetic stripe to support a point of service terminal that accepts magnetic stripes,
and
b.) a smartjacket,
wherein the universal smartcard is docked within the smartjacket, wherein the smartjacket comprises:
a Bluetooth Low energy chip (BLE),
a WiFi chip,
a secure element,
MCU Firmware, wherein the MCU firmware comprises an add-card application, a select-card application, a delete-card application, an authenticate-user application, a power-management application, and an SSL-like protocol application,
a controller, wherein the controller comprises a microprocessor or microcontroller,
selector buttons for entering input commands, wherein the display on the smartcard displays the selected card account in conjunction with the selector buttons on the smartjacket,
a biometric scanner for securely selecting and unlocking a card account applet on the smartcard for use at any point of service terminal, and
a rechargeable battery which provides power to the smartcard,
wherein the secure element of the smartjacket comprises a smartjacket-mobile pairing applet, a smartjacket-card pairing applet, and a CID-AID mapping table for sending commands to the smartcard to select and unlock specific payment card applets for use at a point of service terminal,
wherein the secure element of the smartcard comprises a smartjacket-card pairing applet and wherein the secure element of the smartcard stores multiple account applets for use once it is biometrically unlocked via the smartjacket at any standard point of service terminal,
wherein the smartjacket transmits data from the smart card to a mobile device or cloud wirelessly using wireless protocols through the WiFi chip and the BLE chip.

2. The universal smartcard/smartjacket/wearable device of claim 1, wherein the smartjacket and the universal smartcard are not interchangeable in that they are paired so that they can only be used with each other.

3. The universal smartcard/smartjacket/wearable device of claim 2, wherein the smartcard is inserted in the smartjacket and connected via a wired contact connection.

4. The universal smartcard/smartjacket/wearable device of claim 3, wherein the smartjacket-card pairing applet on the smart jacket and the smartjacket-card pairing applet on the smart card verify that the smartjacket and the smartcard are properly paired during docking.

5. The universal smartcard/smartjacket/wearable device of claim 4, wherein the network applet works in concert with an add-card script to create the payment card applet.

6. The universal smartcard/smartjacket/wearable device of claim 5, wherein the PSE and/or PPSE applets allow a selected payment card applet to be used for only one transaction after which they are locked and cannot be unlocked and accessed by a point of service terminal without a subsequent biometric identification entry on the smartjacket.

7. The universal smartcard/smartjacket/wearable device of claim 6, wherein an app on a mobile device is used to upload card account information to the smartjacket and wherein the smartjacket securely transfers card account information to the smartcard.

8. The universal smartcard/smartjacket/wearable device of claim 7, wherein the mobile device app requests through the network, tokens and credits for a credit card account from a bank that issued the credit card, wherein the mobile app receives the tokens and credits in the form of an encrypted add-card script from a trusted service manager through the network if approved by the bank, wherein the add-card script is encrypted with keys that are only available to the smartcard, wherein the mobile app transfers the add-card script to the smartjacket and wherein the smartjacket securely transfers the add-card script to the smartcard.

9. The universal smartcard/smartjacket/wearable device of claim 8, wherein the selector buttons on the smartjacket allow a user to navigate between stored cards on the universal smartcard.

10. The universal smartcard/smartjacket/wearable device of claim 9, wherein the smartjacket includes a synch button to exchange data with the cloud and/or applications on a mobile device.

11. The universal smartcard/smartjacket/wearable device of claim 10, wherein the smartjacket operates to wake the smartcard from sleep mode.

12. The universal smartcard/smartjacket/wearable device of claim 11, wherein the smartjacket verifies that an action being made on the smartcard originates from a designated user through the biometric sensor.

13. The universal smartcard/smartjacket/wearable device of claim 12, wherein the smartjacket comprises a LED.

14. The universal smartcard/smartjacket/wearable device of claim 13, wherein the LED illuminates to confirm authorization of use of the smartcard, to confirm connection to a wireless service and to confirm charging of the smartjacket battery.

15. The universal smartcard/smartjacket/wearable device of claim 14 comprising a logical verification, wherein the logical verification comprises a unique code setting which allows the smart card and smartjacket to read data transmitted from each other, wherein the smartcard and smartjacket each comprise an app which decrypts encrypted communications transmitted between the smartjacket and the smartcard.

16. The universal smartcard/smartjacket/wearable device of claim 15, wherein the logical verification is extended by pairing with an app on a mobile device.

17. The universal smartcard/smartjacket/wearable device of claim 16, wherein both physical and logical verifications must be passed to use the smartcard, wherein physical verification comprises the smartjacket confirming the user's identity through the biometric scanner.

18. The universal smartcard/smartjacket/wearable device of claim 17, wherein upon passing the physical and logical verifications the smartcard may be removed from the smartjacket and used at the point of service.

19. The universal smartcard/smartjacket/wearable device of claim 18, wherein the smartjacket is operable to directly connect to cloud applications without the assistance of a mobile device and wherein the smartjacket is operable to connect to cloud applications through the use of a smartmobile application in the event that a signal is not available.

20. The universal smartcard/smartjacket/wearable device of claim 19, wherein the smartjacket collects and transmits information regarding purchases and location with cloud applications using a smartmobile application including discounts, wherein the discounts include the retrieval of coupons, loyalty rewards and any other rewards provided by payment methods authorized by the user, wherein the cloud interacts with the smartjacket to display usable discounts on the smartcard and wherein the smartmobile application determines the best payment method for use at the location and recommends a payment method to the user on the display of the smartcard.
